(19) United States
(12) Patent Application Publication
(10) Pub. No.: US 2016/0371780 A1
(43) Pub. Date: Dec. 22, 2016

(54) SYSTEM AND METHOD FOR PERSONAL INVESTING

(71) Applicant: Vested Interest Co, New York, NY (US)

(72) Inventors: Jane Barratt, New York, NY (US); Peter Zdanowicz, New York, NY (US)

(21) Appl. No.: 15/078,934

(22) Filed: Mar. 23, 2016

Related U.S. Application Data
(63) Continuation-in-part of application No. 14/846,912, filed on Sep. 7, 2015, now abandoned.
(60) Provisional application No. 62/046,287, filed on Sep. 5, 2014.

(51) Int. Cl. G06Q 40/06; G06Q 40/04

(52) U.S. Cl. CPC G06Q 40/06; G06Q 40/04

(57) ABSTRACT

A system and method for providing personal investment recommendations to individuals according to their purchasing information.

### FIELD OF THE INVENTION

The present invention is of a system and method for personal investing, and in particular, to such a system and method for selecting one or more personal investments according to brand familiarity and/or brand purchase experience.

### BACKGROUND OF THE INVENTION

First-time and novice individual investors often struggle with where and how to begin their investment journey. Popular retail trading platforms such as those offered by E-trade® and Charles Schwab® enable the execution of trades, however many beginner individual investors feel that they know too little about investing to use these platforms effectively.

Further, if they do create accounts, many investors struggle with a lack of confidence and a lack of investment ideas to get started and create their first portfolio. As a result, first-time and novice individual investors participate in the market at lower rates than other more sophisticated individual investors, and many people do not get started at all due to a lack of understanding of the market fundamentals and insider terminology.

### SUMMARY OF THE INVENTION

The investment world is stacked in favor of the institutions and the individuals that serve it. Individuals without experience can find it difficult to start investing for personal benefit, as they don't understand such investments and do not know how to start weighing the various important factors that are necessary for successful investments. Unfortunately the background art does not solve such problems with investments.

The system and method of the present invention, in at least some embodiments, redresses that imbalance and return power into the hands of personal investors, by enabling them to select one or more personal investments according to brand familiarity and/or brand purchase experience. In the latter role, users of the system and method are leveraging their knowledge and familiarity as customers of the brands (or their underlying companies) for selecting investments, such that the system and method may be said to close the linear path of money and effort into a circular cycle of spending and reward.

According to at least some embodiments, the present invention provides a simple, digital based stock recommendation platform that analyses consumer credit card history, mixed with public and proprietary data to guide them where to start their investment journey, and build their first portfolio.

Optionally, the users may leverage the stock recommendation platform for customer loyalty and increased brand advocacy.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, including, but not limited to, a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, any type of mobile device, a PDA (personal digital assistant), a pager, or a tablet. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A relates to a non-limiting, illustrative, example of a system according to at least some embodiments of the present invention;

FIG. 1B depicts a system diagram of an exemplary embodiment of a server.

FIG. 2A depicts a method diagram for an exemplary registration process for a new user who is interacting with a user interface.

FIGS. 2B-1 to 2B-4, 2C, 2D and 2E-1 to 2E-6 are exemplary screenshots that a user may be displayed in an exemplary registration process as described in FIG. 2A.

FIG. 2F shows an exemplary method for an exemplary, non-limiting registration process.

FIG. 3A depicts the process of Step 280a from FIG. 2A, “User Selects Personal Path to Investing” from a user perspective.

FIG. 3B depicts the process of Step 280a “User Selects Personal Path to Investing” from a network perspective.

FIGS. 3C, 3C-2 to 3C-5, 3D-1, 3D-2, 3E-1, 3E-2 and 3F-1 are exemplary screenshots that a user may be displayed when interacting with a user interface as described in FIG. 3A.

FIG. 4 depicts the process of Step 280a “User Selects Personal Path to Investing” in more detail from a network perspective.

FIG. 5A depicts the process of Step 280d “User Selects Passive Path to Investing” from a user perspective.

FIGS. 5B and 5B continued are exemplary screenshots that a user may be displayed when interacting with a user interface as described in FIG. 5A.

FIG. 5C depicts an alternative process of Step 280d “User Selects Passive Path to Investing” from a user perspective.

FIG. 5D depicts an alternative process of Step 280d “User Selects Passive Path to Investing” from a network perspective.

FIG. 6 depicts the process of Step 304 “User Rates Publicly-Traded Entities” in more detail.

FIG. 7 shows an exemplary, illustrative non-limiting embodiment of analysis engine 113 from FIG. 1A.

FIG. 8A depicts exemplary input metrics to an analysis engine.

FIG. 9A depicts exemplary inputs to a metric based on financial data affiliated with publicly traded entities.

FIG. 10A depicts exemplary inputs to a metric based on sentiment data affiliated with publicly traded entities.

FIG. 10B depicts alternative exemplary inputs to a metric based on sentiment data.

FIG. 11 depicts exemplary inputs to a metric based on user transaction data affiliated with publicly traded entities.

FIG. 12 depicts exemplary inputs related to Company Insiders as depicted in Block 10-01B into a metric based on sentiment data, as shown in Block 804.

FIG. 13 depicts exemplary inputs related to Institutional Investors as depicted in Block 10-02B into a metric based on sentiment data, as shown in Block 804.

FIG. 14 depicts an exemplary input related to Company Customers as depicted in Block 10-03B into a metric based on sentiment data, as shown in Block 804.

FIG. 15 depicts exemplary individual inputs to a Sentiment metric or Sentiment score depicted in Block 804.

FIG. 16 depicts an exemplary embodiment and inputs into a Balance Module, 705, and a Fund Module 706.

FIG. 17 depicts an exemplary embodiment and exemplary inputs into a Portfolio Generator 709.

### DESCRIPTION OF AT LEAST SOME EMBODIMENTS

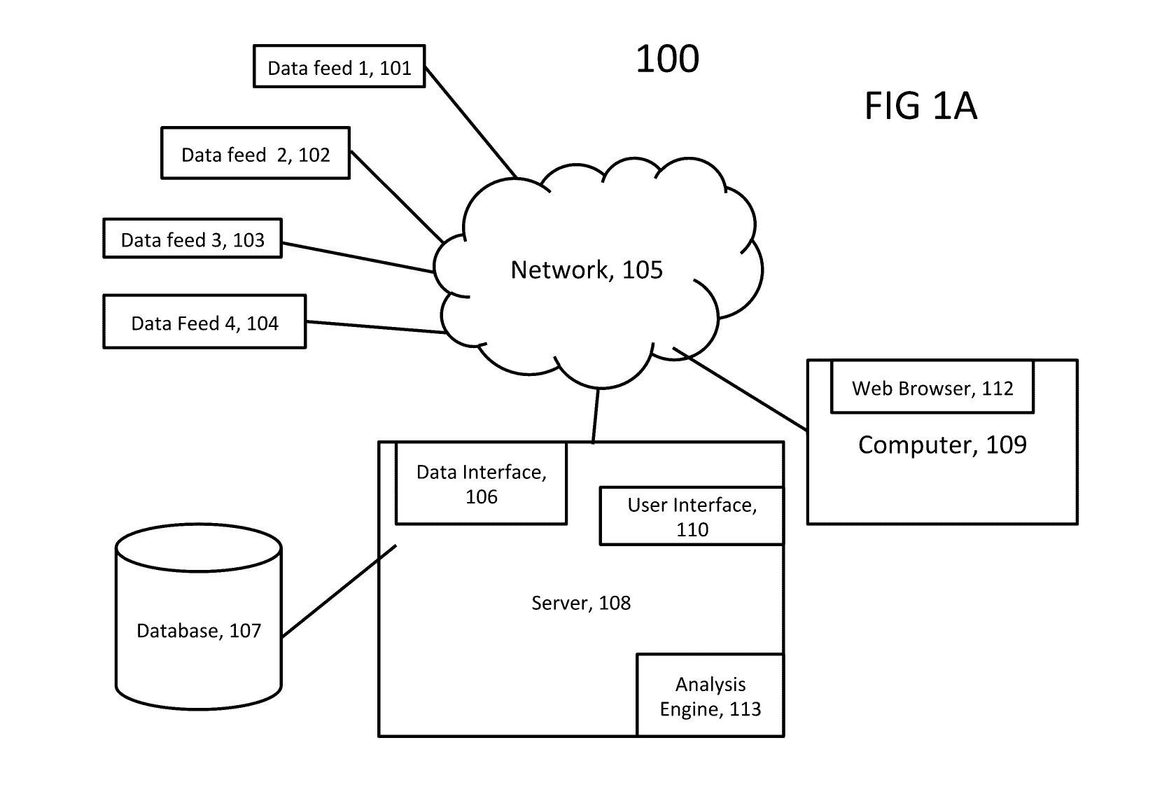

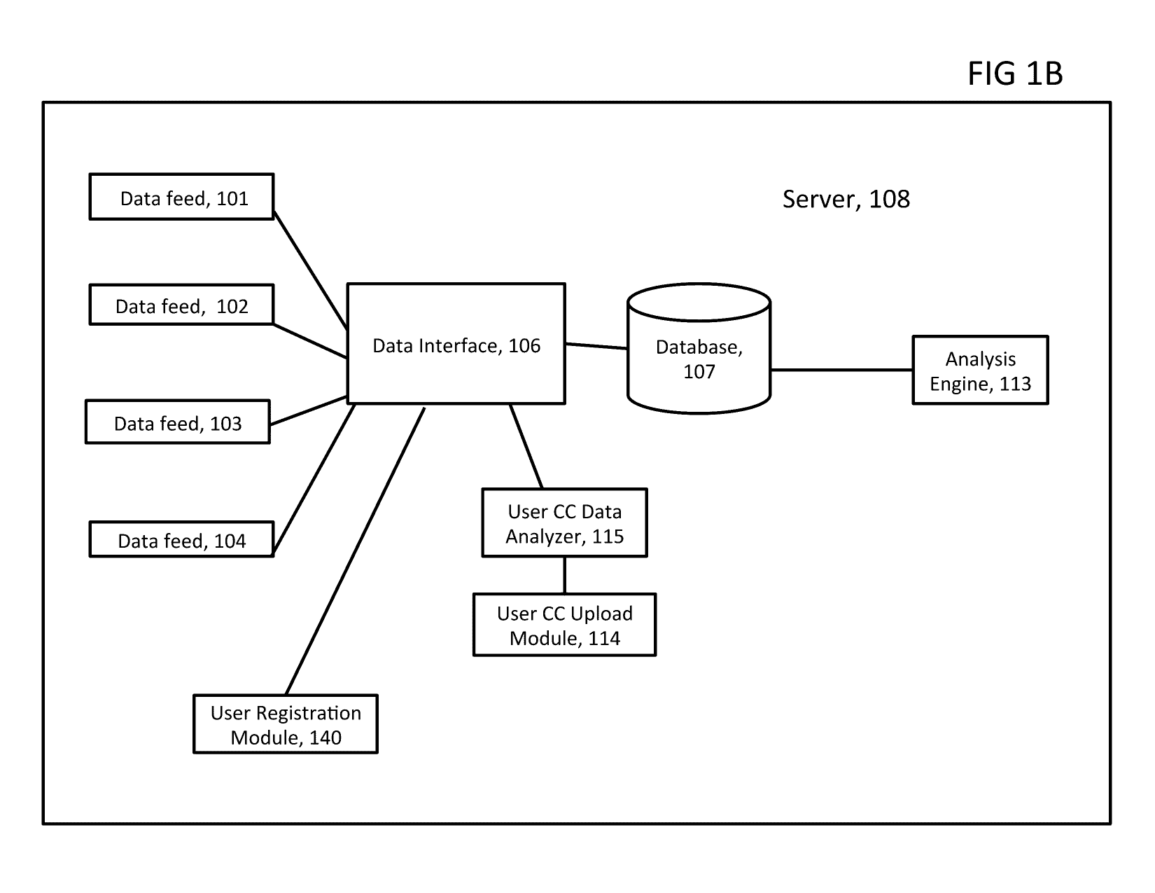

Turning now to the drawings, FIG. 1A shows an exemplary, illustrative system according to at least some embodiments of the present invention. As shown, a system 100 includes a user computer 109 for being operated by a user. User computer 109 may optionally operate a web browser 112 for interaction with the user.

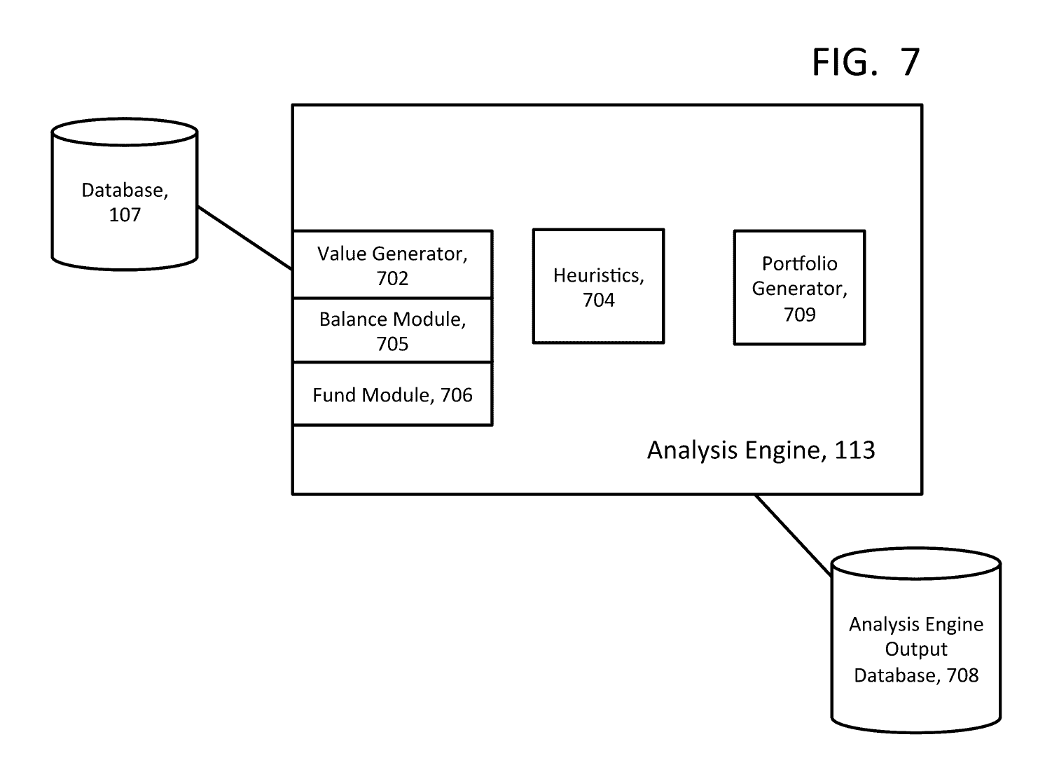

User computer is in communication with a server 108 through a computer network 105, which may optionally be the Internet for example. Server 108 may optionally comprise a plurality of computational devices as depicted in FIG. 1B. Server 108 operates a user experience interface 110, which is in communication with user computer 109 via a web browser, 112, for example. The user enters information, makes selections through a web browser 112, which then passes this data to user experience interface 110. User experience interface 110 in turn provides data to analysis engine 113 and/or stores the data in a database 107. Database 107 also provides data to analysis engine 113, and may optionally also be located outside of server 108 (not shown). A more detailed diagram of analysis engine 113 is depicted in FIG. 7.

User experience interface 110 may receive information from web browser 112 related to user transaction data and stores the data in a database, 107. As noted above, at least some data is provided to analysis engine, 113. Exemplary data which may be provided to analysis engine 113, include data regarding various publicly traded entities via external data feeds 101-104, and user-generated data regarding user transaction history and other identification and financial information via a user interface, 110. Analysis engine 113 analyzes the data to inform recommendations to users regarding potential investment opportunities informed at least in part by their personal transactional data.

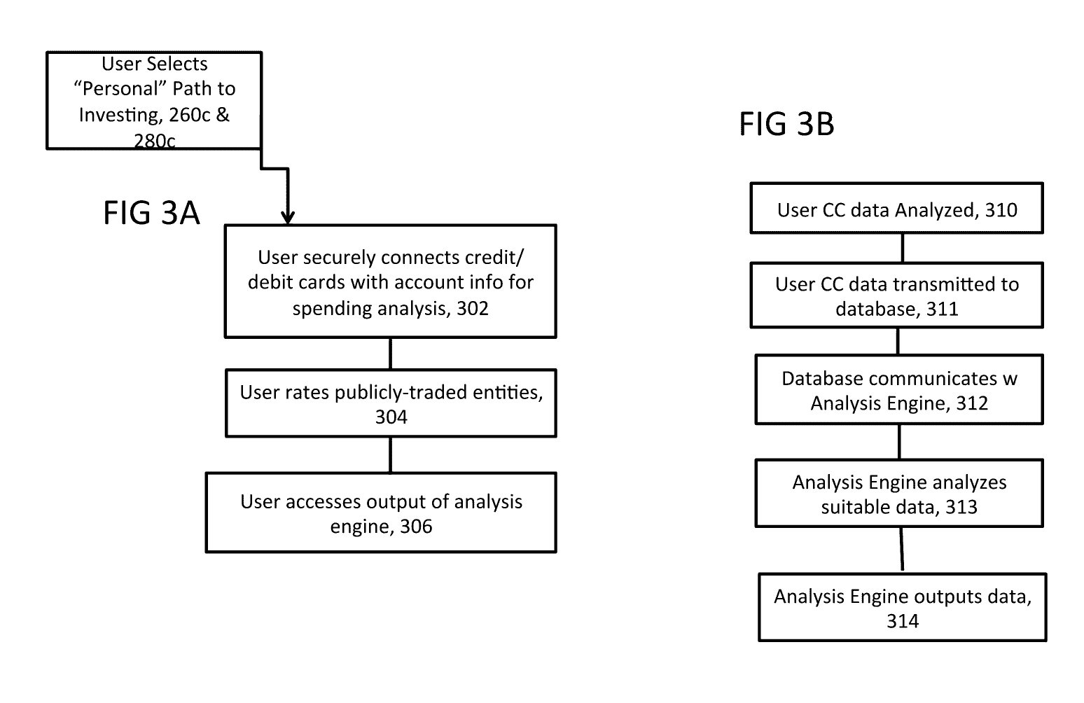

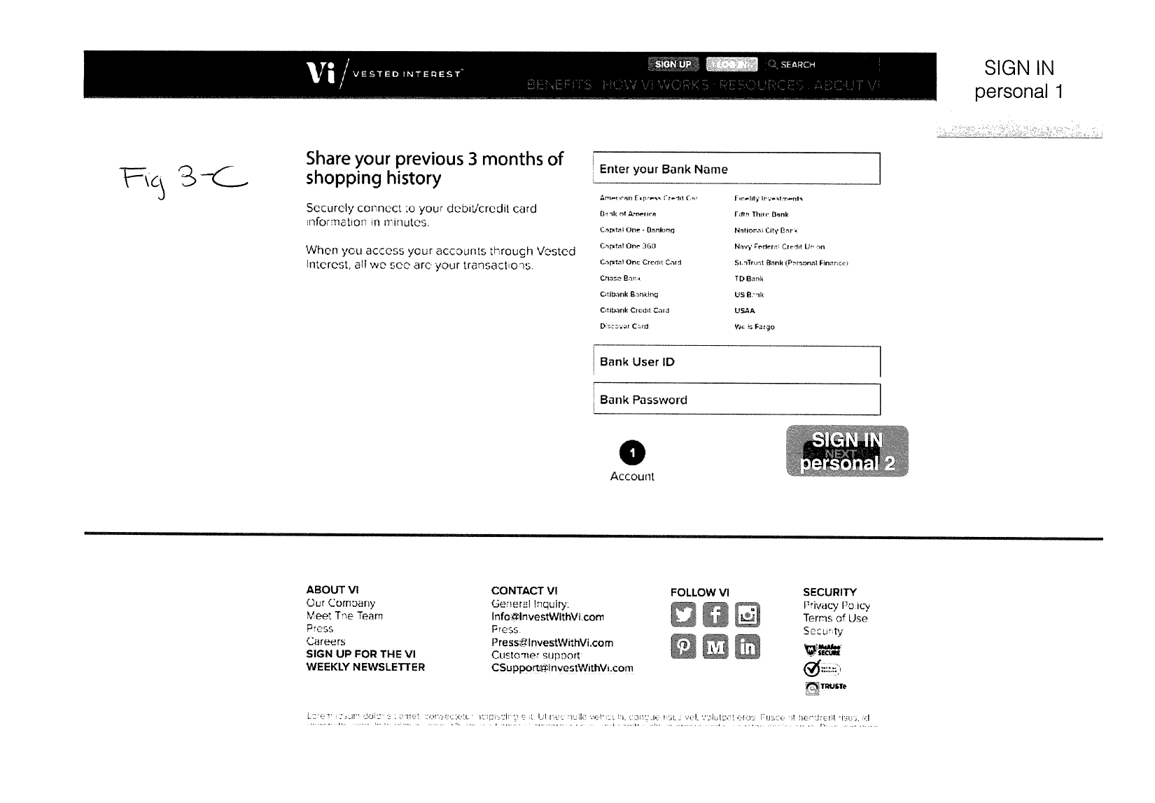

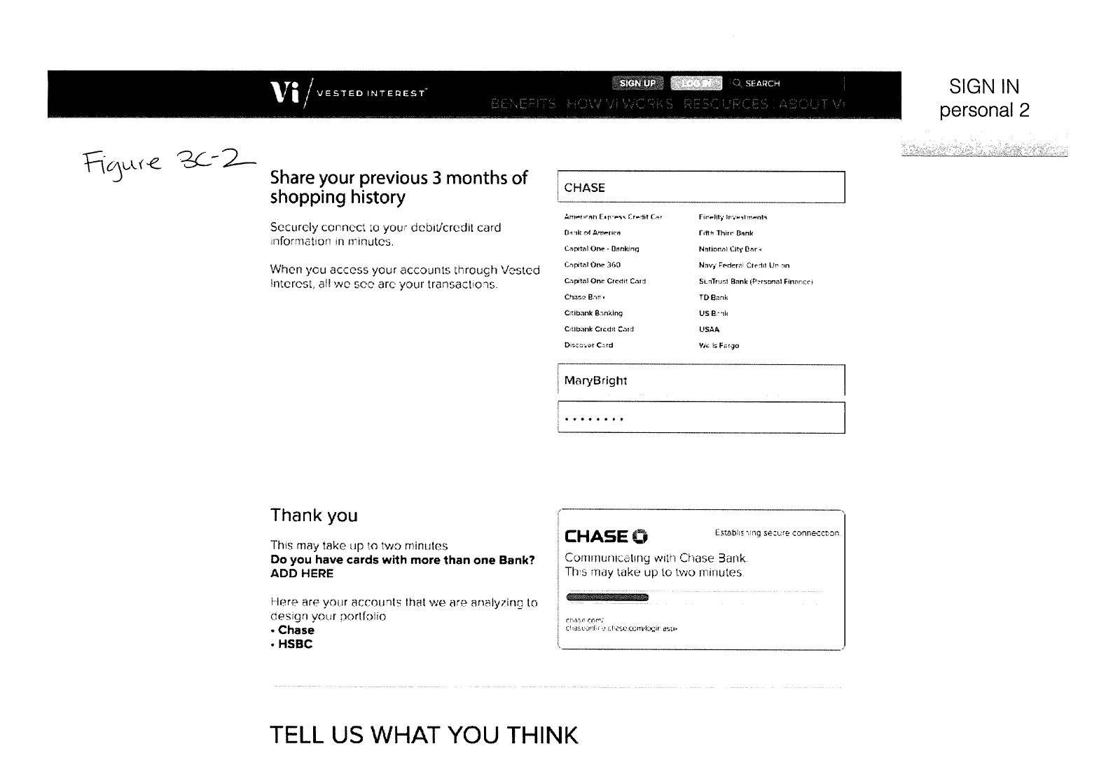

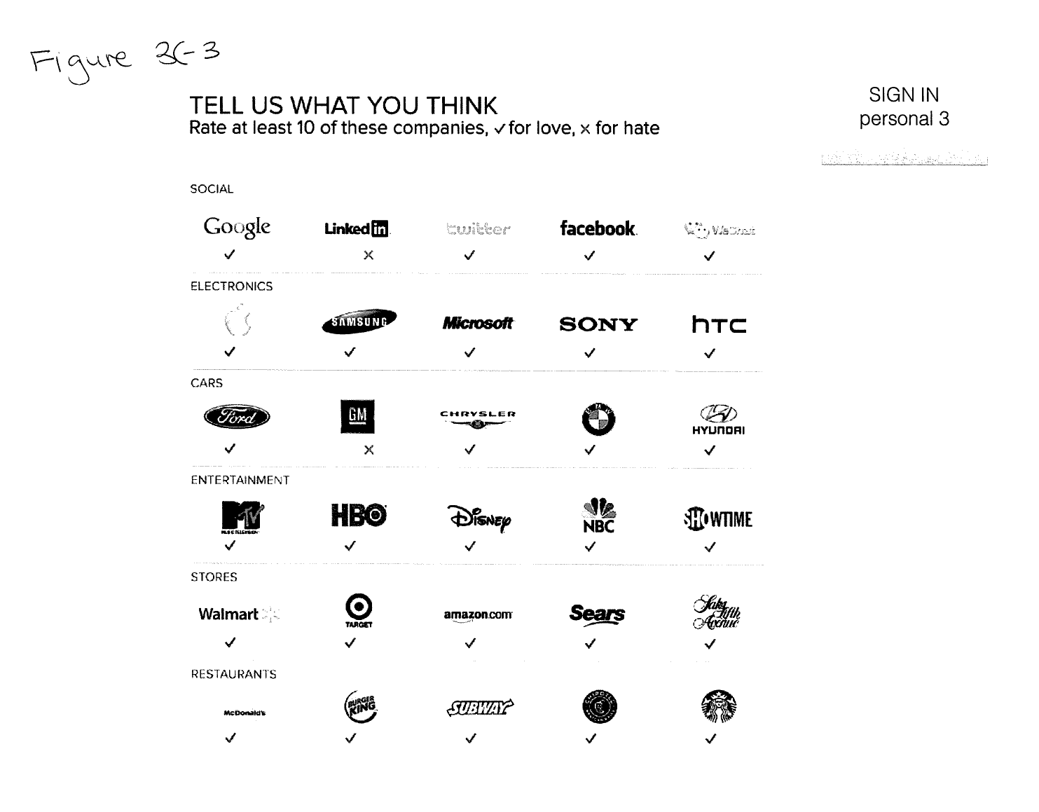

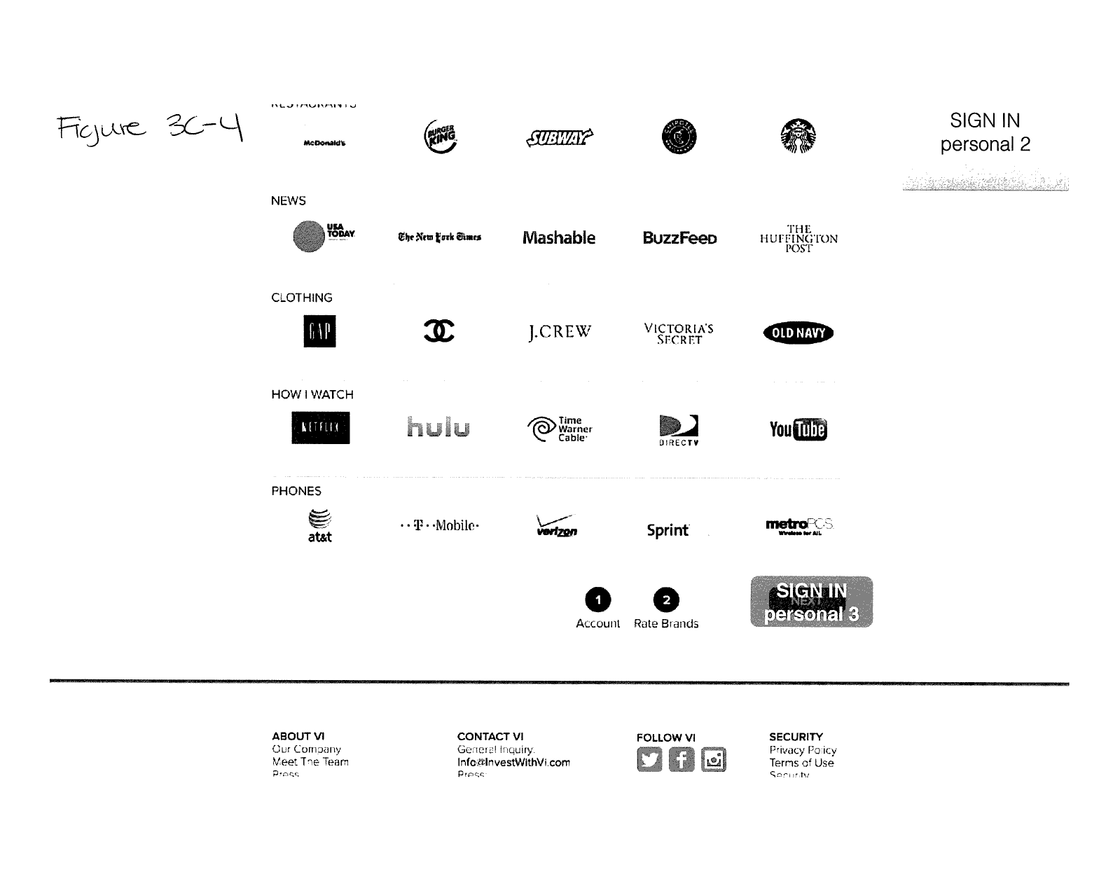

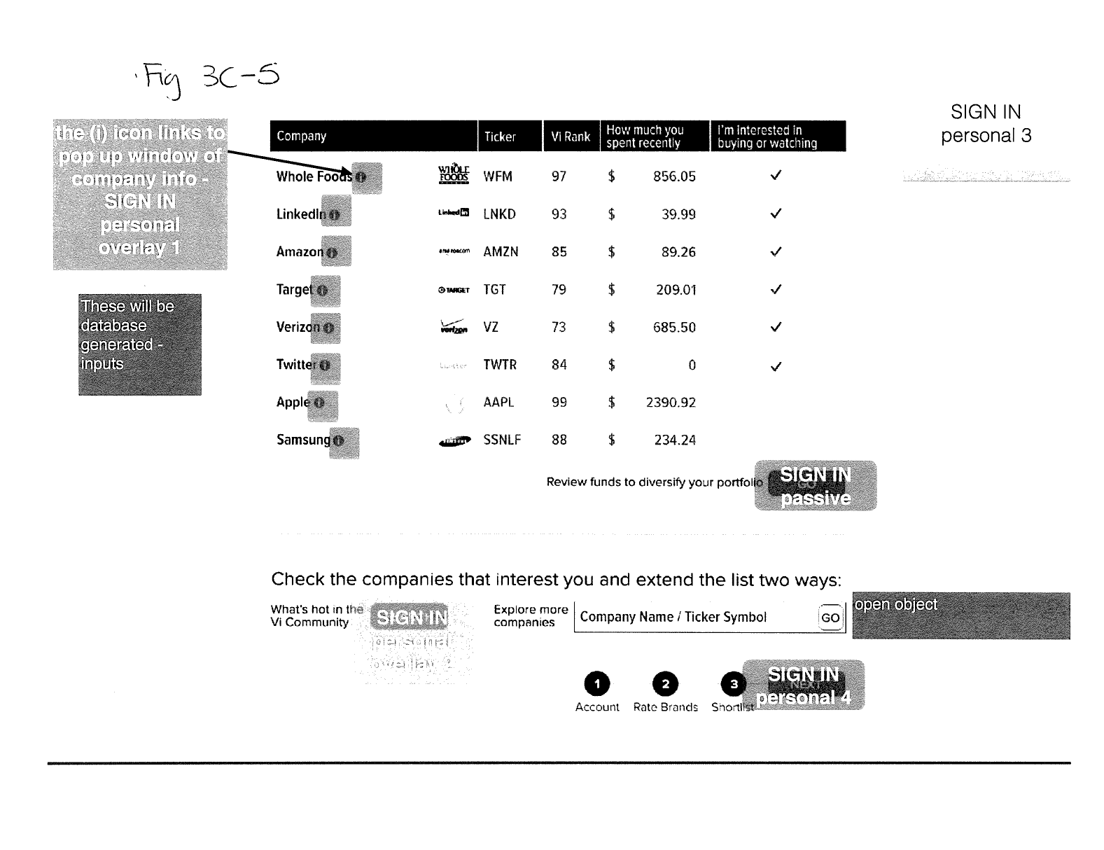

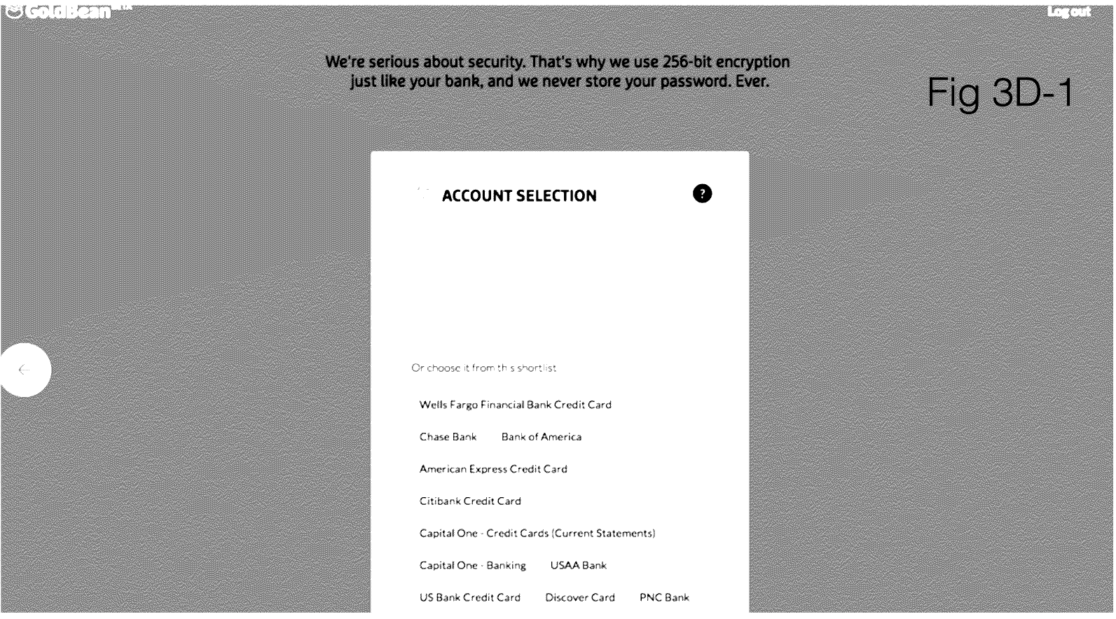

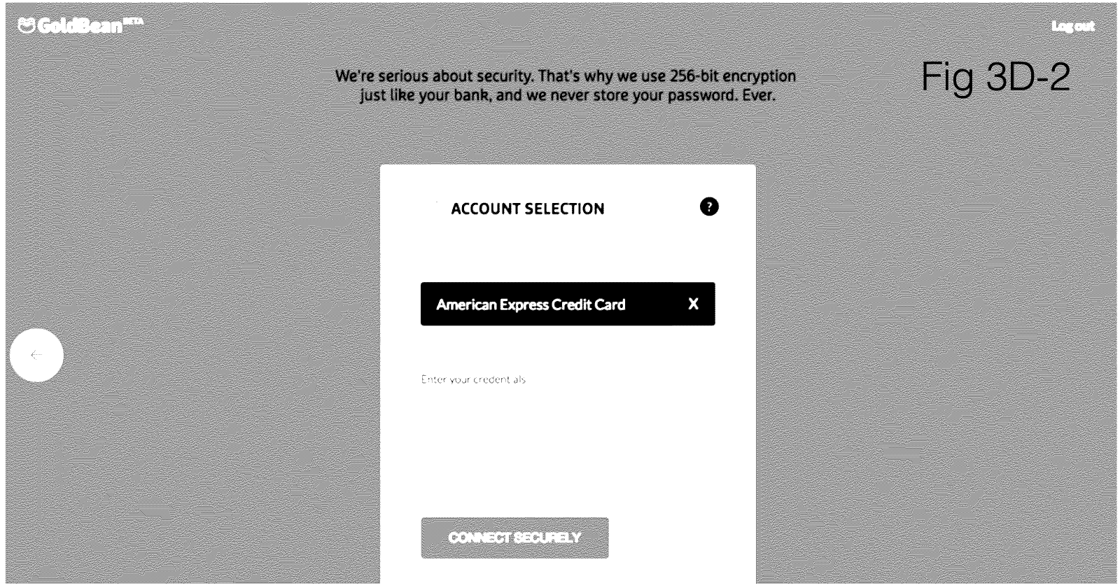

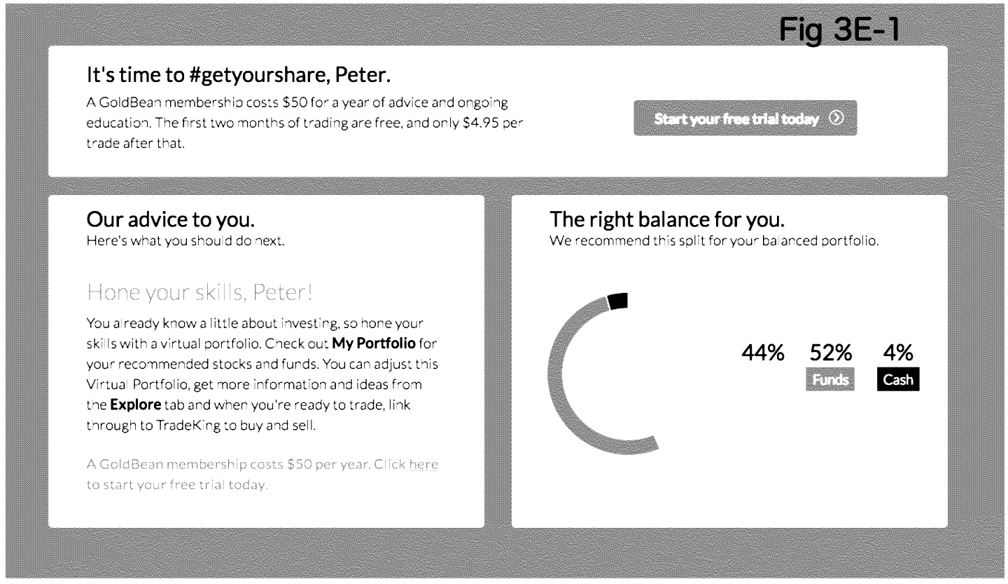

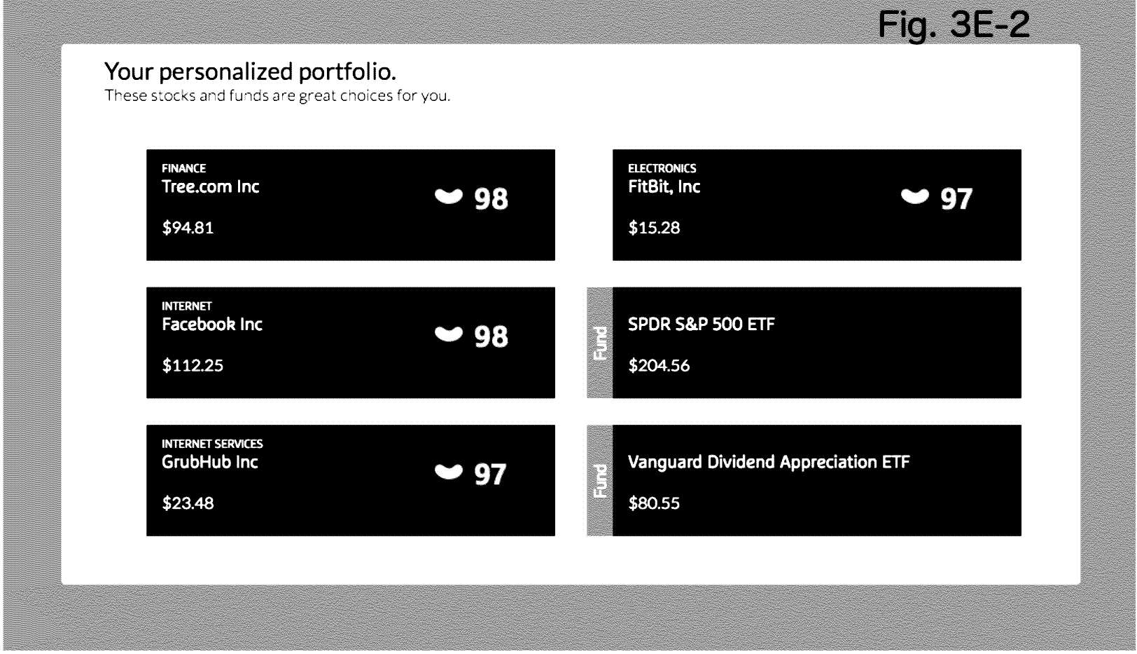

In operation for a registered user, the user logs in or is otherwise identified by entering a username and password through web browser 112. Next, the identifying information is provided to user experience interface 110, which then retrieves the necessary information about the user from database 107. User experience interface 110 then transmits a customized display to web browser 112, which may include an updated real time depiction of a user's investment portfolio which is described further in step 306 of FIG. 3A.

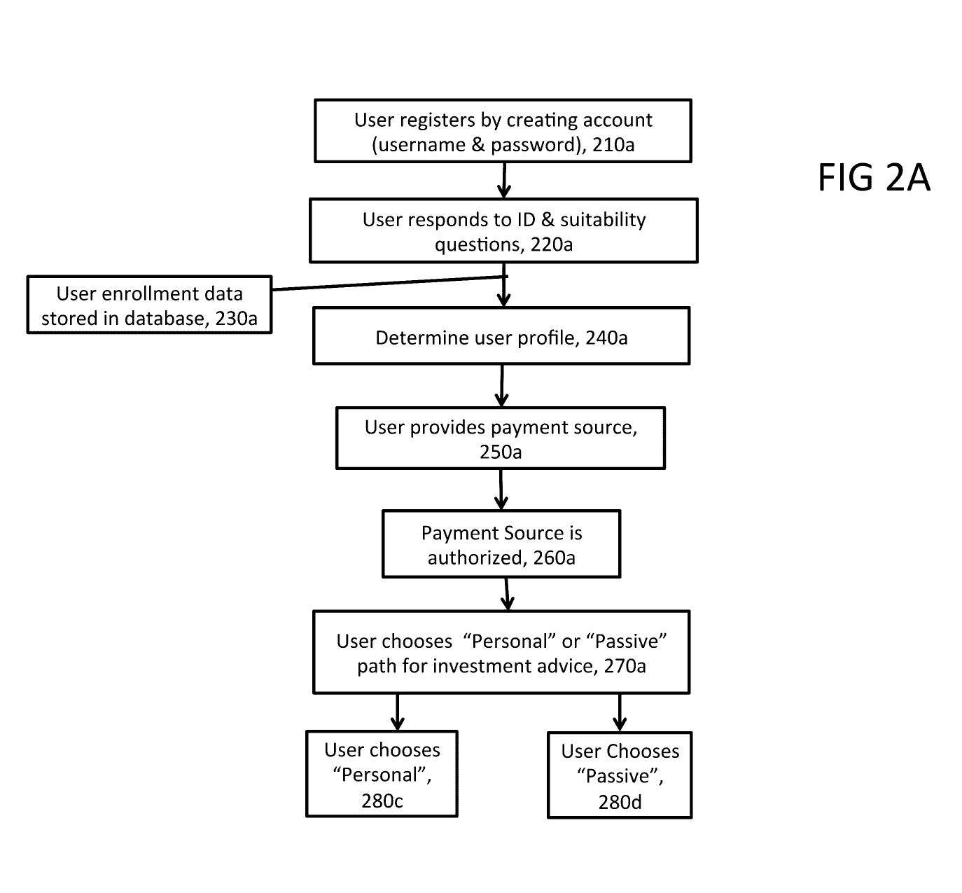

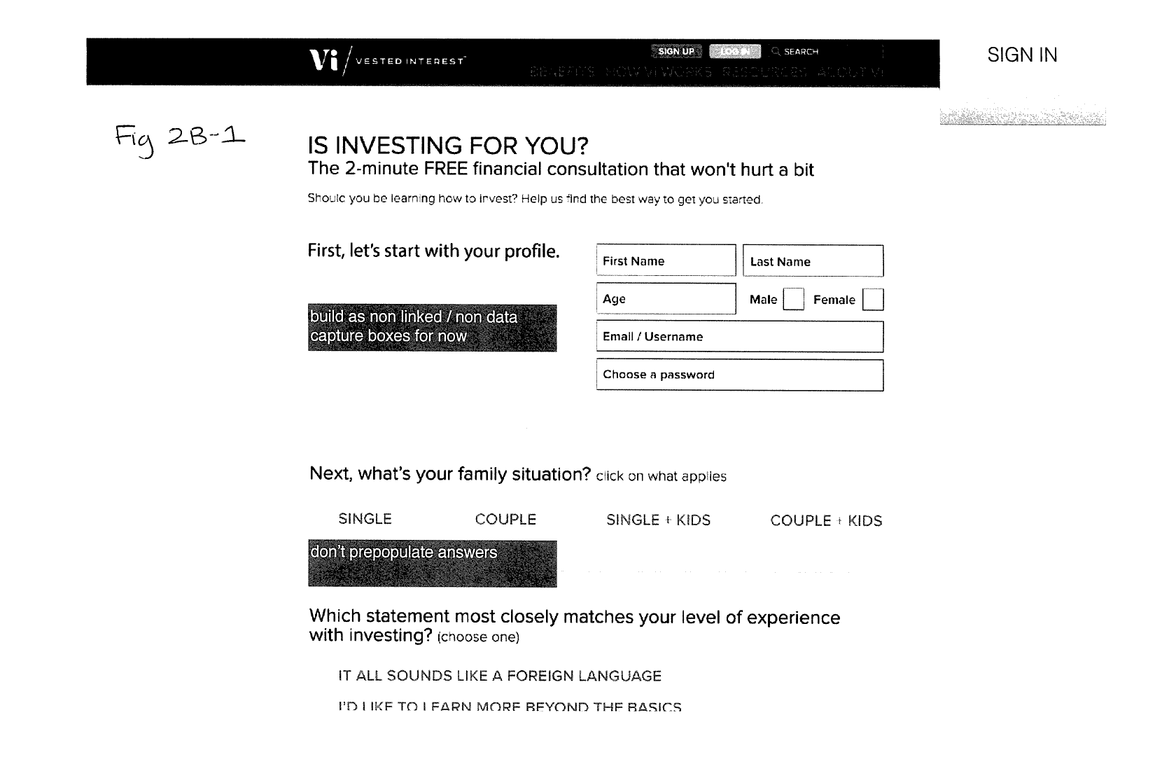

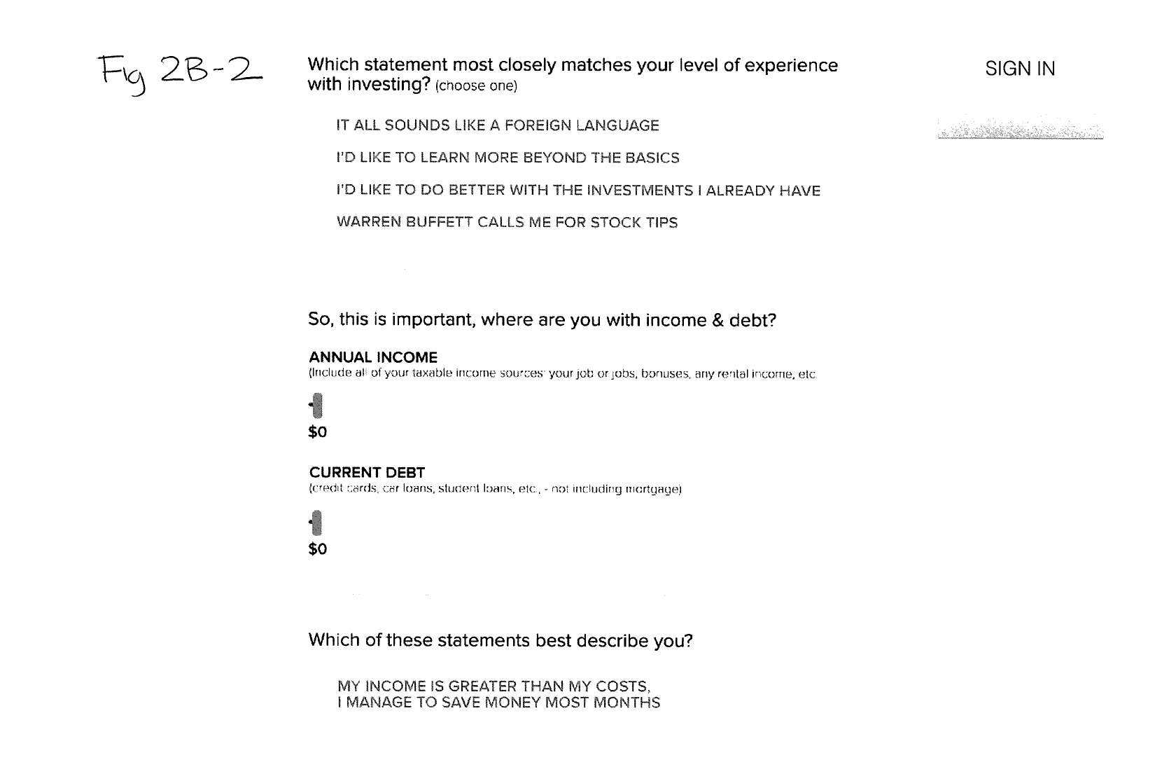

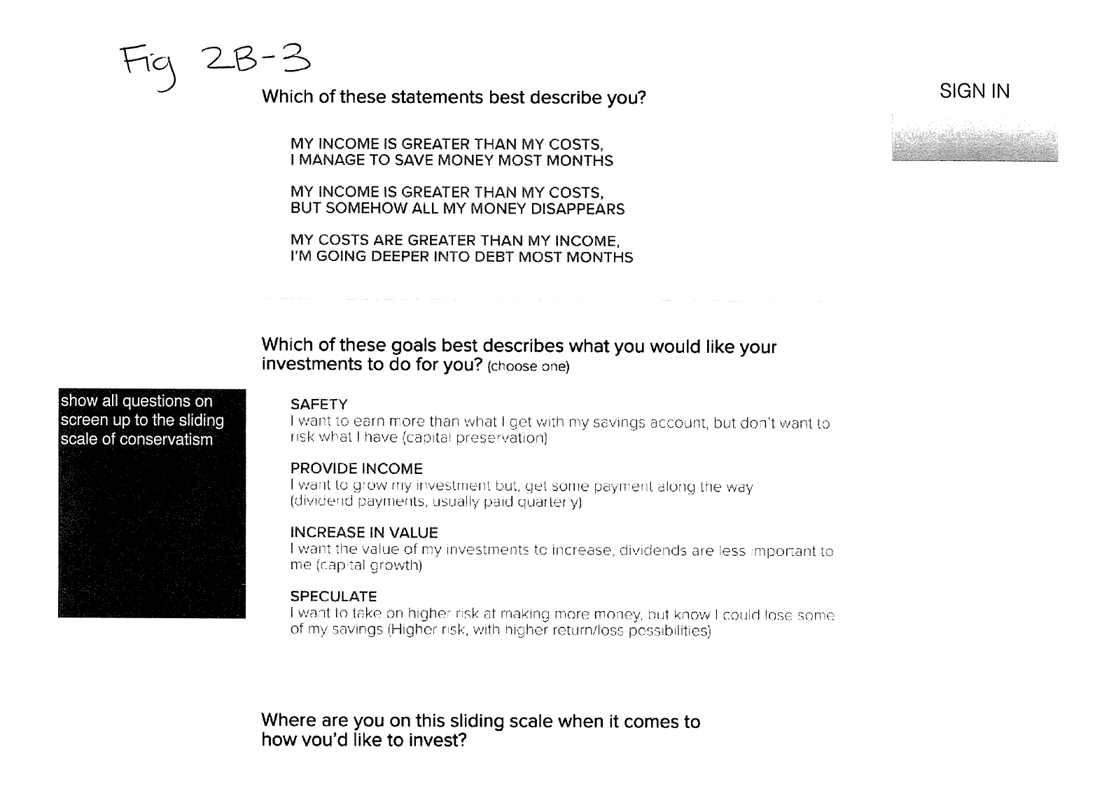

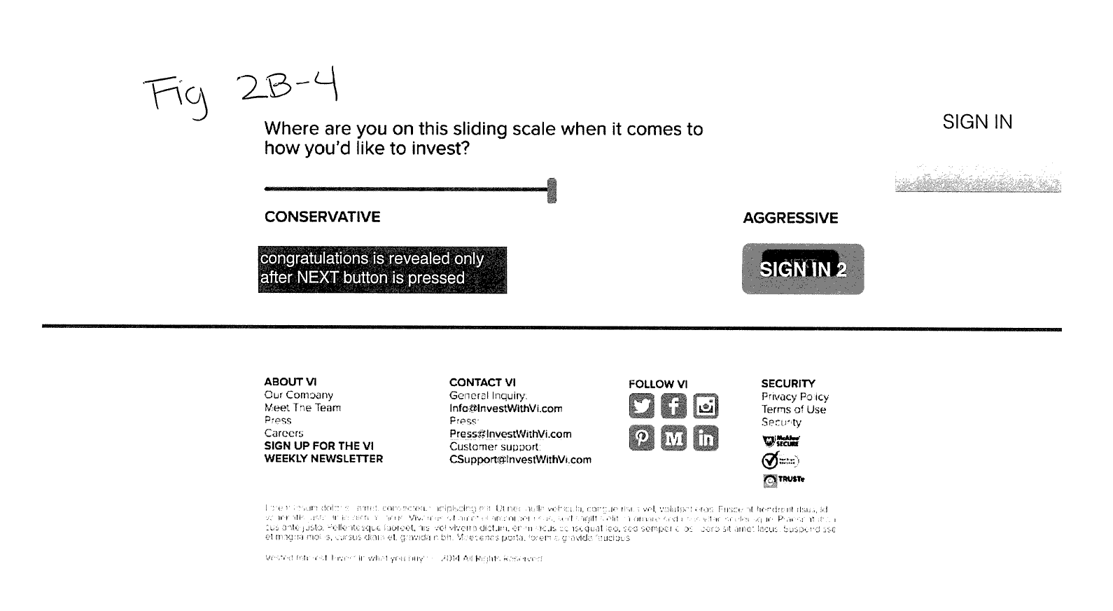

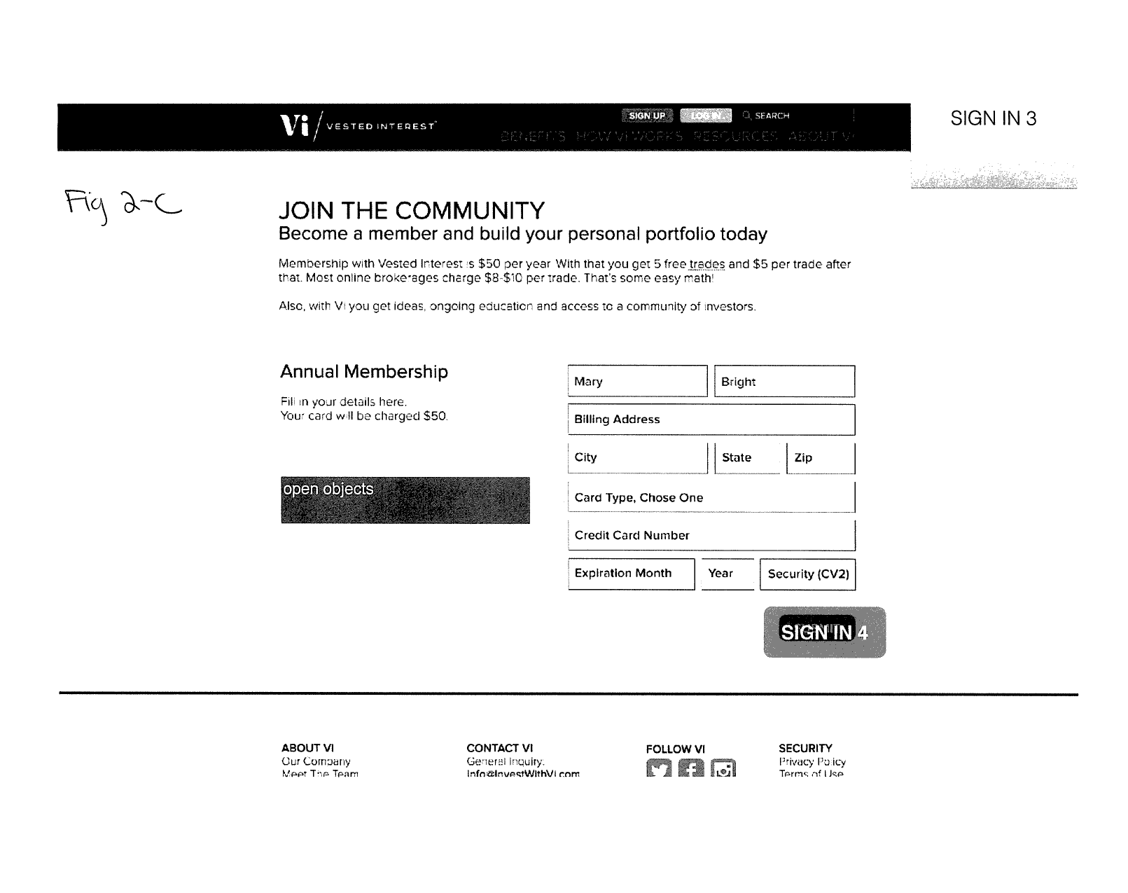

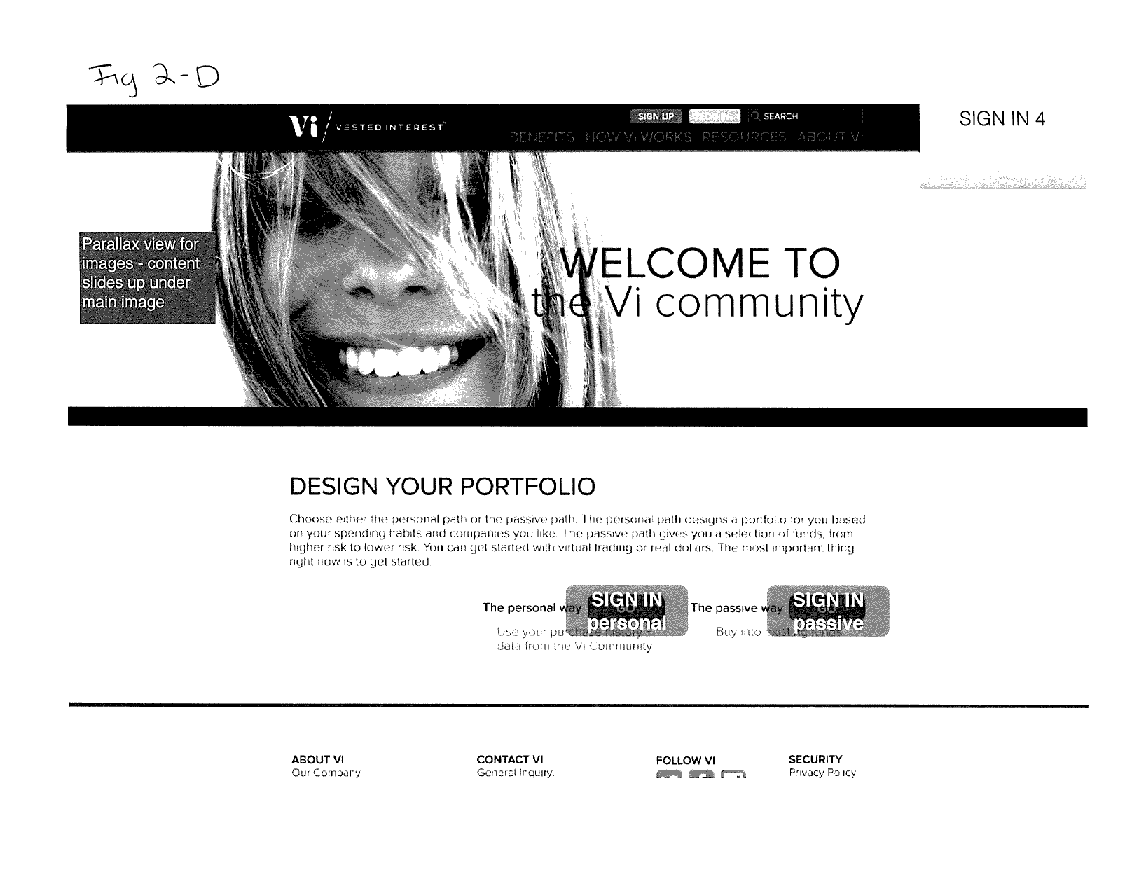

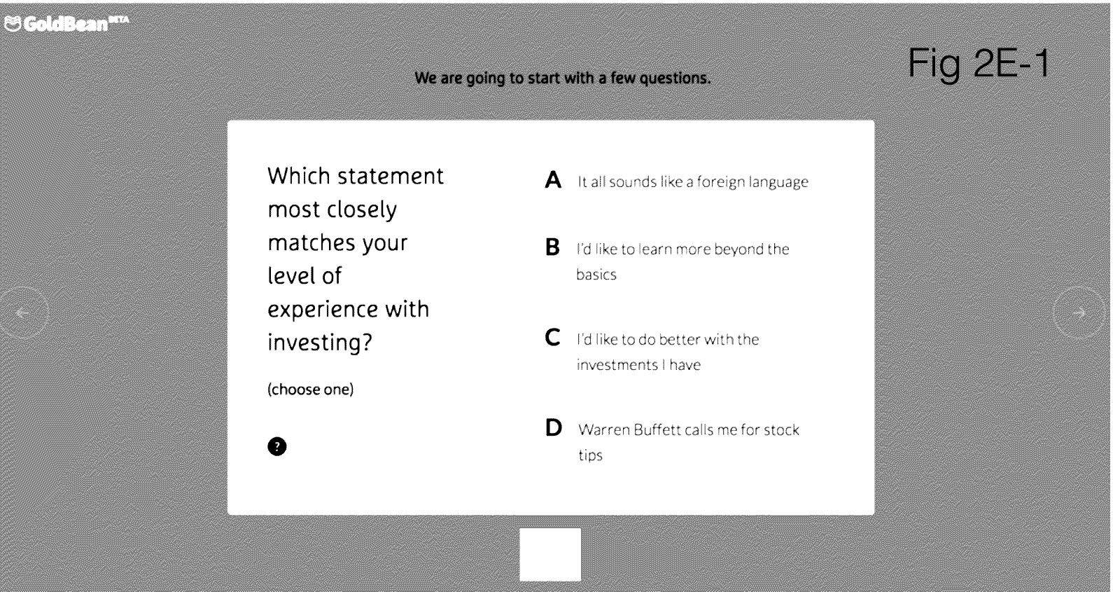

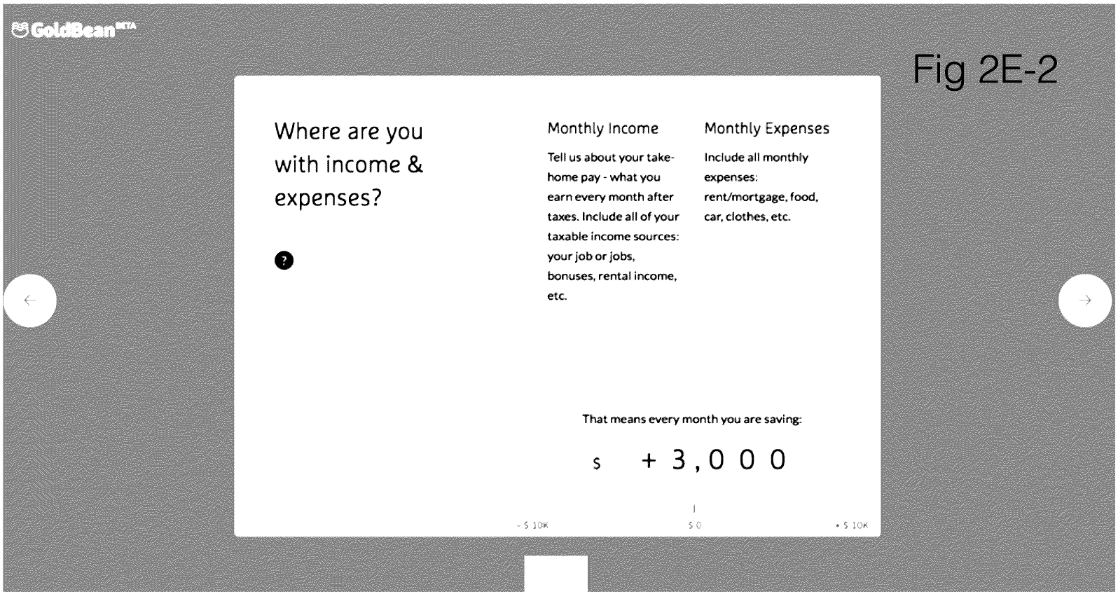

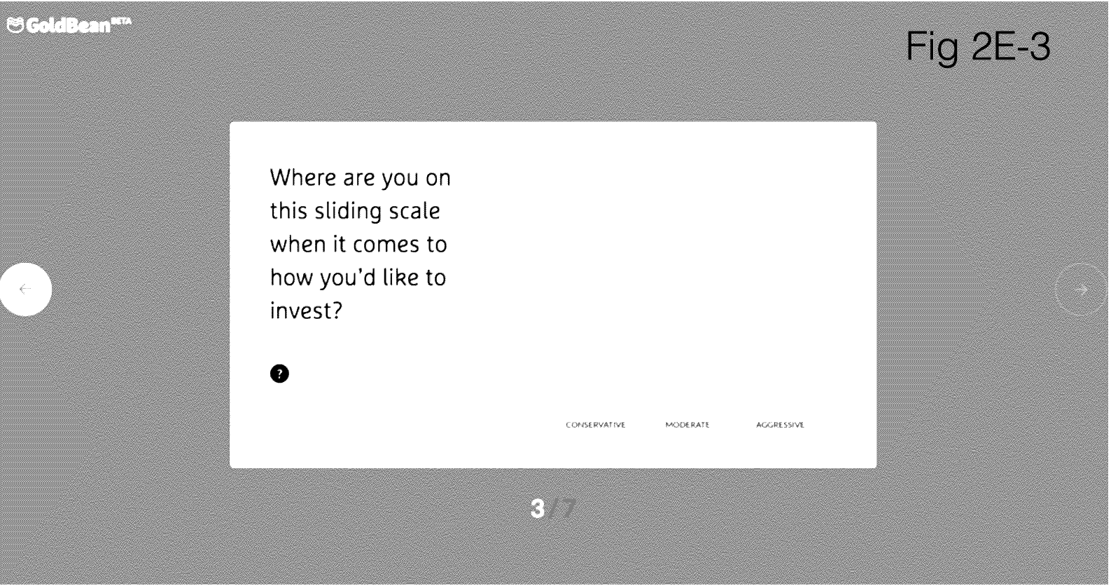

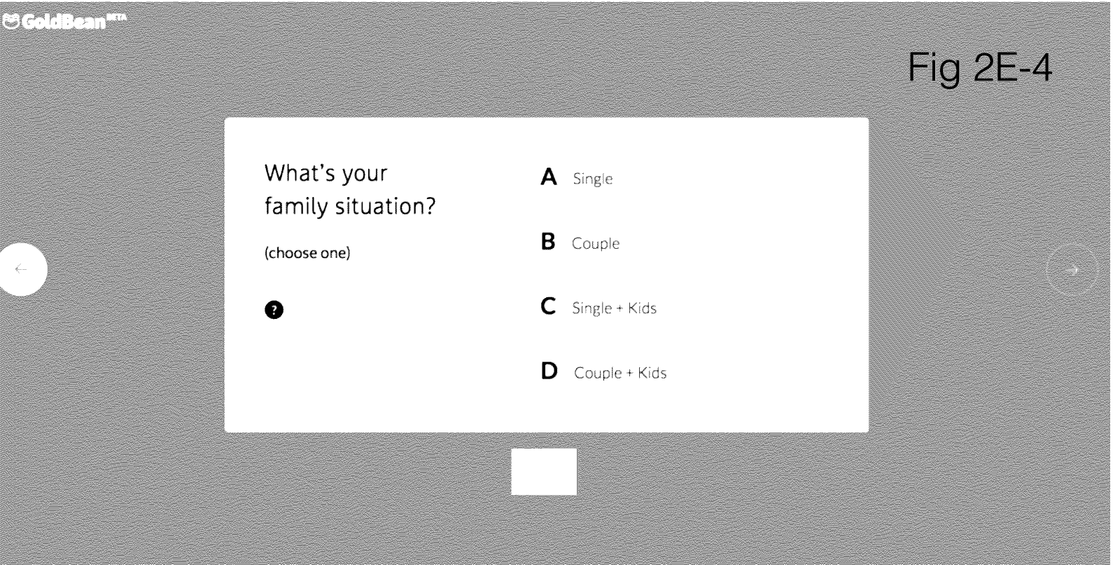

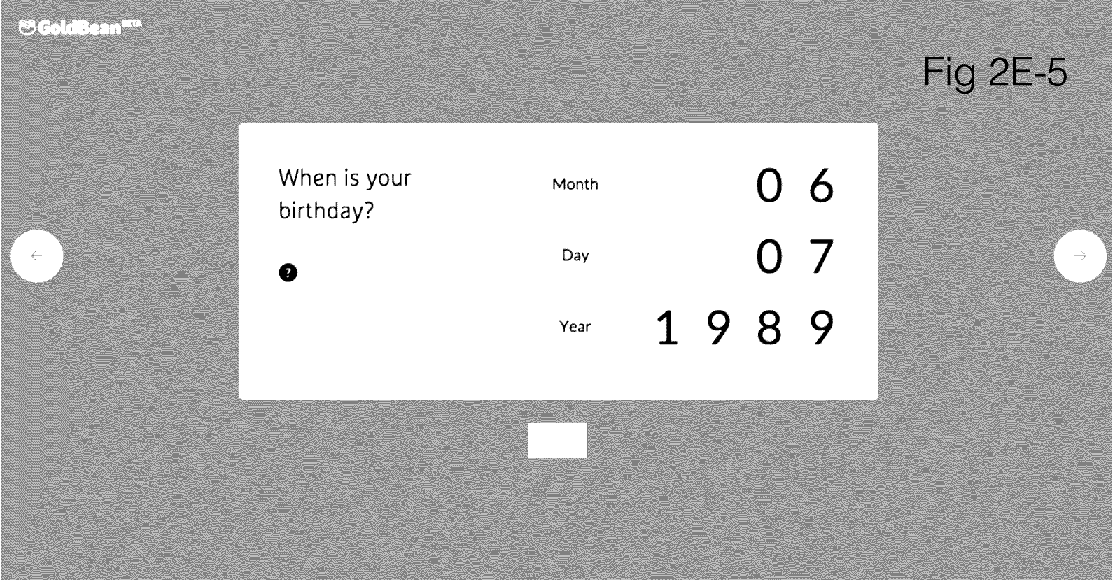

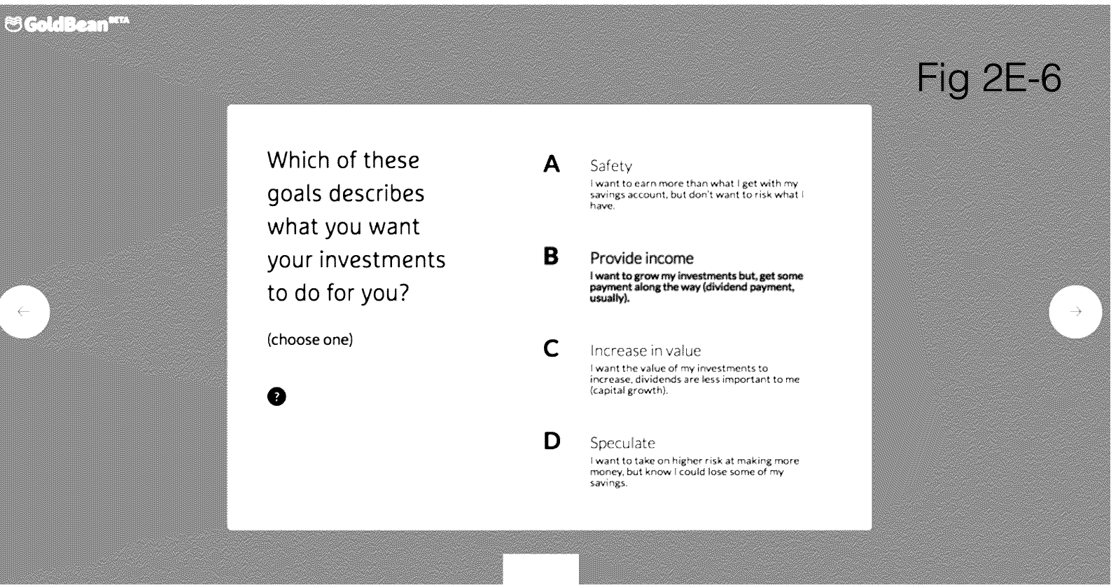

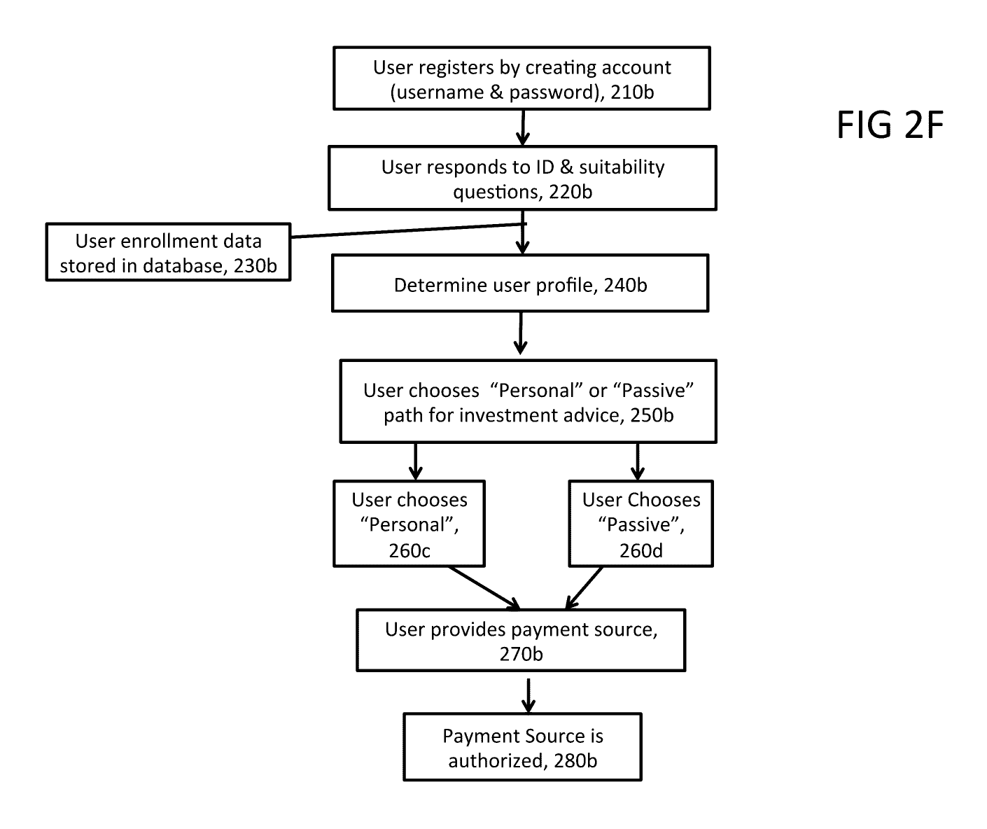

The process differs for a new user vs. an existing user. User registration for a new user is described in detail in FIG. 2F. After registration, the process continues in FIG. 3.

### FIG. 1B.

FIG. 1B shows an exemplary, illustrative server (108) according to at least some embodiments of the present invention.

Server (108) may be configured to receive data from external data feed providers 101-104. Data received through these feeds is provided to a database interface 106 and is stored in database 107.

Database 107 also communicates with a user registration module 140, which is part of user interface 110 according to at least some embodiments of the present invention.

Further yet, database 107 may receive user generated transaction history via a user credit card upload module 114. User credit card upload module 114 may communicate with a user credit card analyzer 115, which determines which transactions from a user's account are affiliated with publicly traded entities and which are not. Database 107 may communicate with user credit card analyzer 115 to access and store user transaction data.

Further, server (108) may host an analysis engine 113, which communicates with database 107 regularly and receives information regarding publicly traded entities on a regular scheduled time-frame, optimally daily, weekly, or monthly for example.

### FIG. 2

FIG. 2 depicts an exemplary registration process for a new user who is interacting with a user interface such as a web browser, app, or thin client, for example, to access personalized investment advice linked to their spending history via analysis of their transaction history via their credit/debit card accounts.

Beginning the registration process in Step 210 the user interacts with a user interface, such as user interface 110, which may be in the form of a website or an app, in order to register for access to personalized investment advice based on the user's personal spending history. This process occurs via a user registration module (140), such as the one depicted in FIG. 1B.

Following this in Step 220, the user is prompted through a user interface to respond to a series suitability questions regarding their financial state in order to determine their risk profile for investing. For example, the user may be asked to provide details regarding their marital status, annual income, annual level of debt, debt to income ratio, experience with investing, goals for investing, and risk tolerance for investing, as well as other relevant questions in order to determine a suitable profile for the user with regard to investment products.

FIGS. 2B1-2B4 are exemplary screenshots depicting a possible identity and financial suitability question-interaction session via the user interface in order to determine a suitable risk profile for a user seeking investment advice based on their personal spending history.

For example, in FIG. 2B1 a user may be asked to provide information regarding their marital status and whether or not they have children. In FIG. 2B2, a user may be shown a series of statements depicting various sentiments toward investing, and asked to chose the statement that most closely matches the user's own level of experience with investing.

Further in FIG. 2B2, a user may be asked to provide an estimate of their annual income and current debt levels. Continuing in FIG. 2B3 for example, a user may be asked to choose a statement that best describes the relationship between their current income and their debts.

In FIG. 2B4 for example, a user may be asked to identify their approach to investing on a sliding scale with conservative at one end, and aggressive on the other.

FIGS. 2E1-2E7 are exemplary screenshots depicting an alternative identity and financial suitability question-interaction session via the user interface in order to determine a suitable risk profile for a user seeking investment advice based on their personal spending history.

For example, in FIG. 2E1 a user may be shown a series of statements depicting various sentiments toward investing, and asked to chose the statement that most closely matches the user's own level of experience with investing.

Further in FIG. 2E2, a user may be asked to provide an estimate of their monthly income and monthly expenses.

Further in FIG. 2E3, a user may be asked to graphically identify their risk level when it comes to investing on a scale from conservative, moderate, to aggressive, for example.

Continuing in FIG. 2E4 a user may be asked to provide information regarding their marital status and whether or not they have children.

Continuing in FIG. 2E5, a user may be asked to provide their age. Continuing in FIG. 2E6, a user may be shown a series of statements depicting various goals for investing, and the user may be asked to pick which goal-statement best describes their own personal goals for investing.

Finally, in FIG. 2E7, a user may be asked to provide an estimate of their current assets and current debt. Of course the process may optionally include different and/or additional screens for information gathering.

Continuing the registration process in Step 230, user-generated data is transmitted and stored in a database, for example, database 107, as depicted in FIG. 1A and B. This process occurs via the data interface, for example the data interface 106, as depicted in FIGS. 1A and B.

Continuing the process in Step 240, a user's responses to potential questions asked in Step 220 are analyzed in order to determine a suitability profile with regard to investment products, according to securities regulations and industry ethical standards.

Depending on a user's risk profile, the experience may optionally be restricted to trading virtual money only.

The registration process continues in Step 250a, where a user is prompted via a user interface to enter a payment method in order to gain access to the stock recommendation platform (of which the system of FIGS. 1A & 1B provides a non-limiting example). For example, a user may be prompted via a user interface to provide a payment source. Continuing in Step 260, a user's payment source is debited when the user selects “SUBMIT”, for example.

FIG. 2C is a screenshot of an exemplary payment-method capture system. In one embodiment the payment method capture system may capture information such as the user's legal name, the user's billing address, the user's payment method (for example, debit card, credit card, PayPal account, wire transfer, electronic check), the unique number associated with the user's payment type (if any), the expiration month & year of the user's payment type (if any), and the security code associated with the user's payment type, if any.

FIG. 2G depicts an alternative registration process for a new user where in Step 250b a user is prompted via a user interface to choose either a “Personal” path to investing, (Step 280c) or a “Passive” path to investing (Step 280d) before providing payment info in Step 270B. Both Step 280c and Step 280d are illustrated in more detail further in the drawings.

FIG. 2D is a screenshot of potential words and images displayed via a user interface that may prompt a user to choose either a “Personal” path or a “Passive” path to accessing investment advice, as portrayed in Step 280c and Step 280d.

FIGS. 2F1-2F3 are alternative depictions of potential words and images to be displayed via a user interface that may prompt a user to choose either a “Personal” path or “Passive” path to accessing investment advice.

### FIG. 3

FIG. 3A shows a more detailed example of the process of Step 280a from FIG. 2A, as described from a user perspective, according to at least some embodiments of the present invention.

Beginning with Step 280a, where a user selects the “Personal” path to investing via a user interface, the process continues in Step 302 of FIG. 3A, where a user may be prompted via a user interface to securely connect credit/debit cards by providing access to their credit card and/or bank account information.

A user may be asked via a user interface to provide their credit card or bank account username and password. FIG. 3C is a screenshot of an exemplary arrangement of words and images that may be displayed to a user at Step 302, in order to securely connect the account of their choice for spending analysis.

The bottom half of FIG. 3C-2 is a screenshot of possible words and images that could be displayed to a user via a user interface in order to communicate that a that a secure connection is being made with a user's financial institution.

FIGS. 3D1 and 3D2 are exemplary alternative words and images that could be displayed to a user via a user interface in order to securely connect the account of their choice for spending analysis, and in order to inform the user that a secure connection is being made with a user's financial institution.

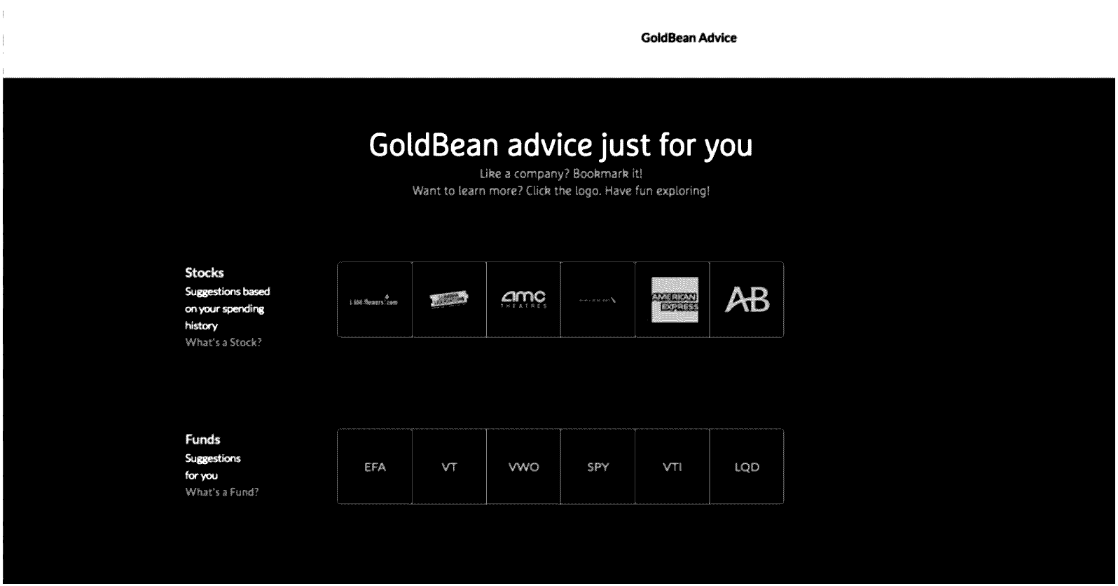

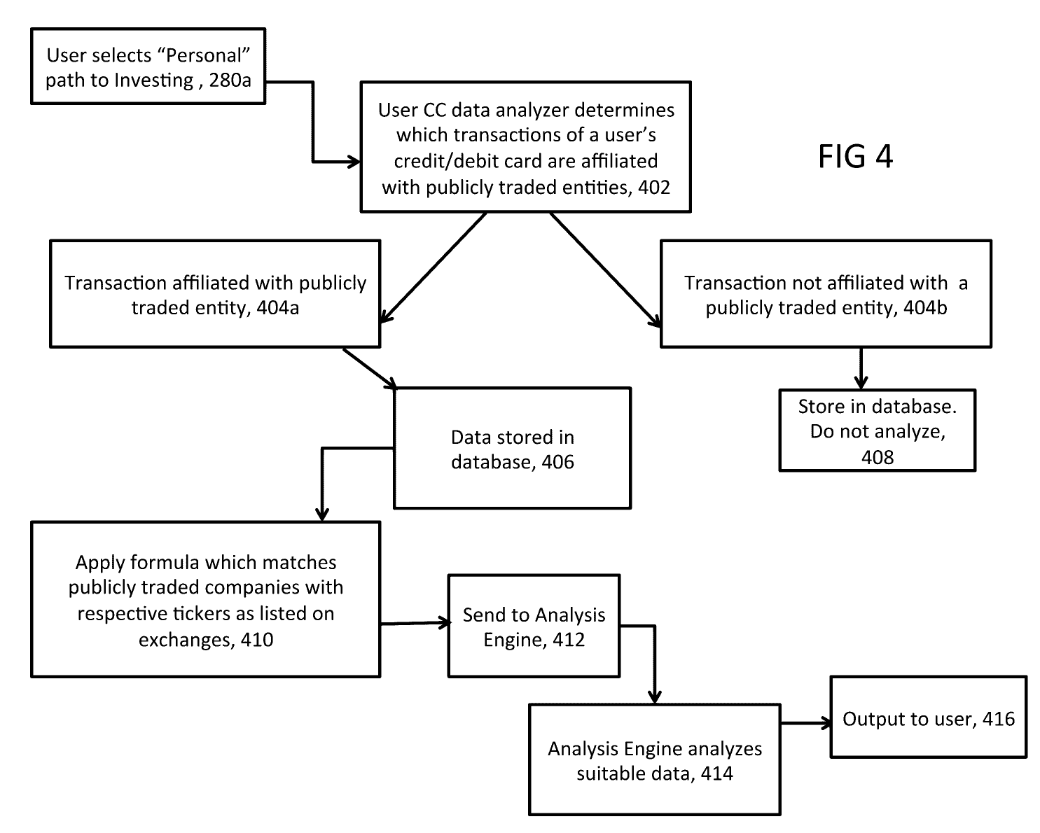

Returning now to FIG. 3A, Step 302 is further described from a network perspective in FIG. 4.

Continuing the process, in Step 304 of FIG. 3A, a user may be prompted to rate various publicly traded entities via user interface.

FIG. 3C-3 is a screenshot of a potential arrangement of logos of publicly traded entities, as well as possible language prompting the user to rate the entities. One skilled in the art will appreciate that logos corresponding to publicly traded entities might be added as new entities list and complete initial public offerings (IPO) on various securities exchanges.

Additionally, FIG. 3C4 is a screenshot of a potential arrangement of logos of publicly traded entities for the user to rate via a user interface.

Alternatively, Step 304 may optionally be omitted and the user may not rate publicly traded entities before receiving output of the analysis engine.

Continuing the process for a user who selects the “Personal” path to investing, in order to access personalized investment advice based on personal spending history, in step 306, the user accesses the personalized advice via a user interface (110).

In one embodiment, the personalized advice may be displayed to a user via a user interface in the form of a chart, list, or other similar tool for organizing information. The chart may be given a name such as a “Model Portfolio”. The chart may correspond to a list of personalized investment opportunities optionally informed by the output of analysis engine 113.

Alternatively and optionally, the output of analysis engine 113 may not be referred to as a “Model Portfolio”, but may be referred to as “recommendations”, “advice”, or another name, and may be displayed to the user in a manner similar to what is depicted in screenshots 3E1 and 3E2.

FIG. 3C5 also illustrates an exemplary model of a “Model Portfolio”, or list of personalized investment advice linked to a user's spending history and optimally informed by the output of analysis engine 113, that may be displayed to a user. In one embodiment the “Model Portfolio” may contain names of various publicly traded entities from a user's personal spending history, Exchanged Traded Funds that match an individual's risk profile, the ticker-symbol used to represent those entities on various exchanges, the current price of those entities and an option for the user to purchase shares of the entity (virtually or actually), or simply watch the entity by placing them in a “Watchlist”.

The selection of investments offered will be a reflection of the risk tolerance that the client is able to handle . . . (Note to Missy . . . May need a “balance engine section”)

FIG. 3F1 further illustrates an alternative arrangement of a list of personalized investment advice linked to a user's spending history and optimally informed by the output of analysis engine 113, that may be displayed to a user.

Turning now to FIG. 3B, the process that occurs in Step 280a is described from a network perspective, according to at least some embodiments of the present invention.

In Step 310 of FIG. 3B, a user's personal transaction history is analyzed via a user credit card data analyzer, 115, such as the one depicted in FIG. 1B. FIG. 4 describes an exemplary analysis of user transactional data in more detail.

In Step 311, data from a user's credit/debit card is transmitted to a database via a data interface such as the one depicted in FIG. 1B. The data interface may be an API from an institution such as Intuit. Exemplary data that may be transmitted include: merchant ID, transaction date, transaction time, and amount spent. One skilled in the art will appreciate that other relevant data may also be transmitted as the information becomes available and is deemed suitable.

In Step 312, an exemplary database, such as database 107 depicted in FIG. 1B, communicates with an Analysis Engine such as the one depicted in 113, via computer readable language in order to access suitable information for analysis. For example, the analysis engine may access user transactional data, as well as data from outside data feed providers at this time.

Continuing in Step 313, an exemplary analysis engine analyzes suitable data regarding publicly traded entities from external data feeds and from user transaction history in order to recommend investment products to users. Analysis engine 113 may optionally run only once but preferably runs multiple times, for example without limitation daily, weekly, or monthly.

In one exemplary embodiment an analysis engine 113 may optionally analyze information such as user transactional data, publicly available financial information regarding publicly traded entities, social media sentiment summation for various publicly traded entities, brand sentiment data for various publicly traded entities, and other relevant data as it becomes available and is deemed suitable for analysis.

Continuing in Step 314, a personal recommendation module 706 such as the one depicted and described in FIG. 7, may optionally analyze user enrollment data that was input via a user interface 110.

Personal recommendation module 706 may optionally determine which publicly traded entities may be suitable investment opportunities for the user based on their financial data and/or preference data, and in accordance with industry standards.

Finally in Step 315, an analysis engine outputs analyzed data by communicating in a computer readable language with a user interface. The analyzed data is displayed to a user via a user interface. The analyzed data may correspond to a ranked list of publicly traded entities from a user's transaction history and further informed by personal recommendation module 706 that would be suitable investment options for a user, in an exemplary embodiment.

### FIG. 4.

FIG. 4 shows a more detailed example of the process of Step 280a from FIG. 2A, as described from a network perspective, according to at least some embodiments of the present invention.

The process begins in Step 402, where a user's transactional history is analyzed via their credit/debit card in order to identify actionable investment opportunities related to the user's personal spending. In Step 402, a user credit card data analyzer determines which transactions from a user's transactional history are affiliated with publicly traded entities.

Step 404a corresponds to an exemplary scenario in which transactions from a user's credit/debit card data are affiliated with a publicly traded entity.

Continuing in Step 406, transaction data from a user that is related to publicly traded entities is deposited and stored in a database, such as database 107 depicted in FIG. 1B.

Continuing the process of analyzing a user's personal transactional history, in Step 410 a formula is applied which matches the transaction data from publicly traded entities to the respective ticker symbol representing the entity on the exchange in which the entity is listed. For example, in one potential embodiment, if a user's transactional history indicates a purchase from Apple, Inc., the corresponding transactional data will be categorized/tagged with the respective ticker for Apple as listed on the NASDAQ stock exchange, “AAPL”.

Further, if a user's transactional history indicates a purchase from a company that is a subsidiary of a larger parent company, the transaction will be categorized according to the parent company and the data will be categorized/tagged with the respective ticker for the parent company. For example, transactional data with a merchant ID of “Banana Republic” corresponding to a purchase from Banana Republic will be categorized/tagged with the ticker “GPS”, as Banana Republic is owned by Gap, Inc.

Continuing the process of analyzing a user's personal transactional history in Step 412, transactional data that corresponds to a publicly traded entity, and has also been categorized with the respective ticker symbol for the entity is sent to an analysis engine 113, which is depicted in more detail in FIG. 7.

Following in Step 414, an exemplary analysis engine may analyze suitable data regarding various publicly traded entities. The data may be sourced from external data feed providers as well as from a user credit card upload module 114, which transmits user-generated transaction data affiliated with publicly traded entities via a user interface.

One skilled in the art will appreciate that the preceding parameters are not prescriptive, or limiting, and an exemplary analysis engine may analyze data from additional sources as they become available and are deemed suitable.

Potential examples of data that may be analyzed by an exemplary analysis engine are discussed further in the detailed description for FIG. 7.

Potential examples of data that could be analyzed are: a user's transactional history, and financial data, social sentiment data, and/or analyst sentiment data corresponding but not limited to a user's transaction history, and informed by user-generated preference data.

Financial information regarding publicly traded entities present in a user's transaction history, social media sentiment analysis regarding publicly traded entities present in a user's transaction history, analyst sentiment regarding publicly traded entities present in a user's transaction history or otherwise selected by the user for analysis.

Coming now to Step 416, analyzed data is generated and displayed to the user via a user interface. Examples of potential outputs to a user may include, but are not limited to, a ranked listing of publicly traded entities affiliated with a user's personal transaction history, (or otherwise indicated for analysis by the user) that are suitable investment options for the user.

Returning now to Step 404b, an exemplary process is shown for a user whose personal transactional data is not affiliated with any known publicly traded entities.

In Step 406, a user's transactional data that is not affiliated with any known publicly traded entity is deposited and stored in a database via a data interface.

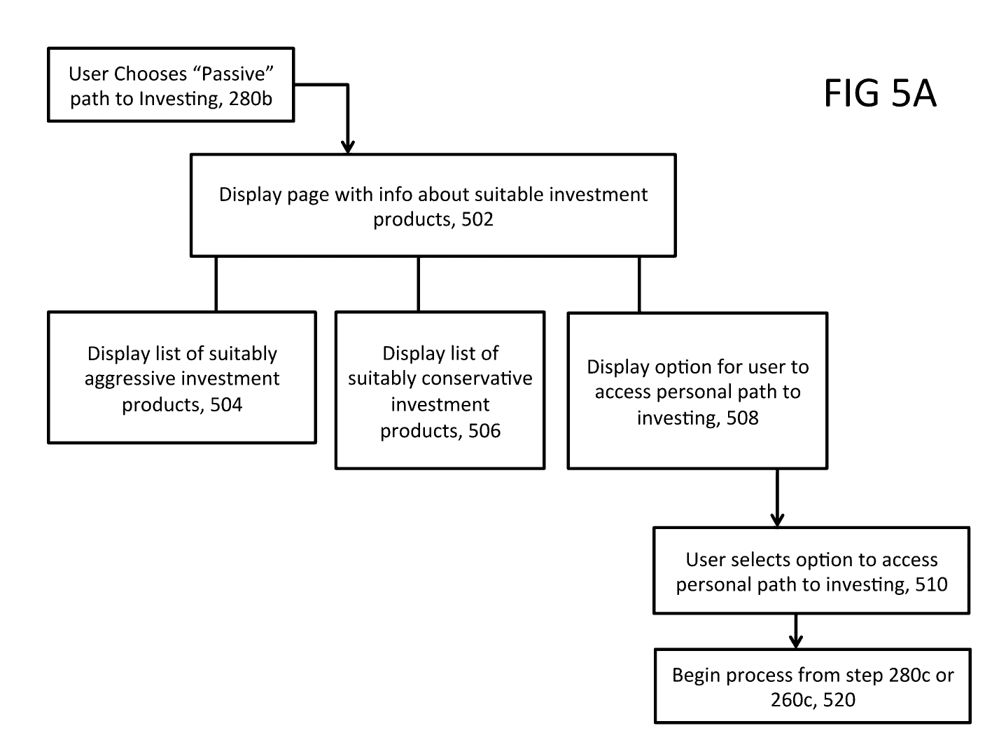

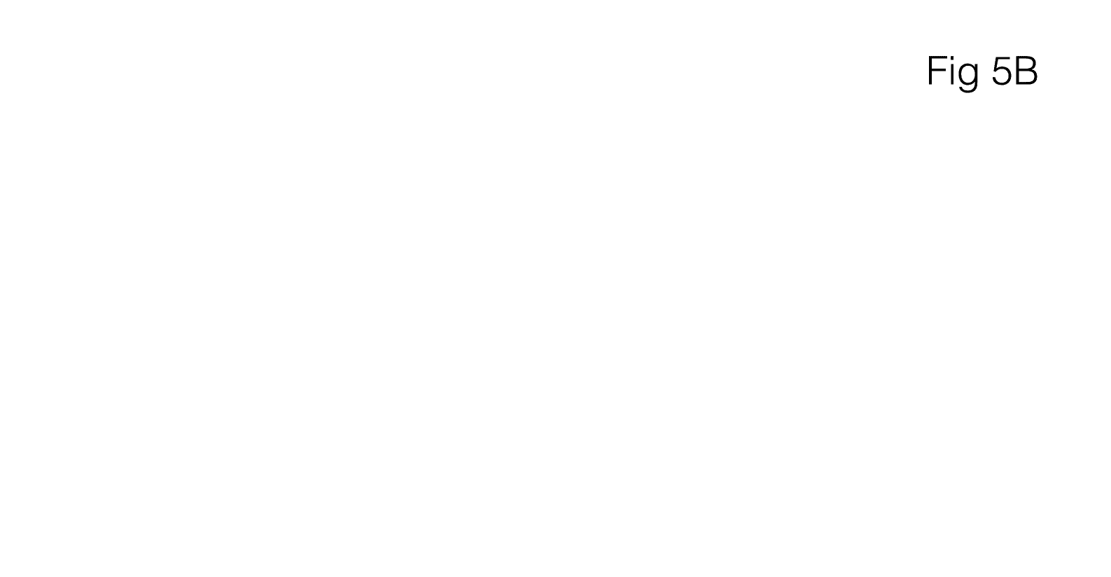

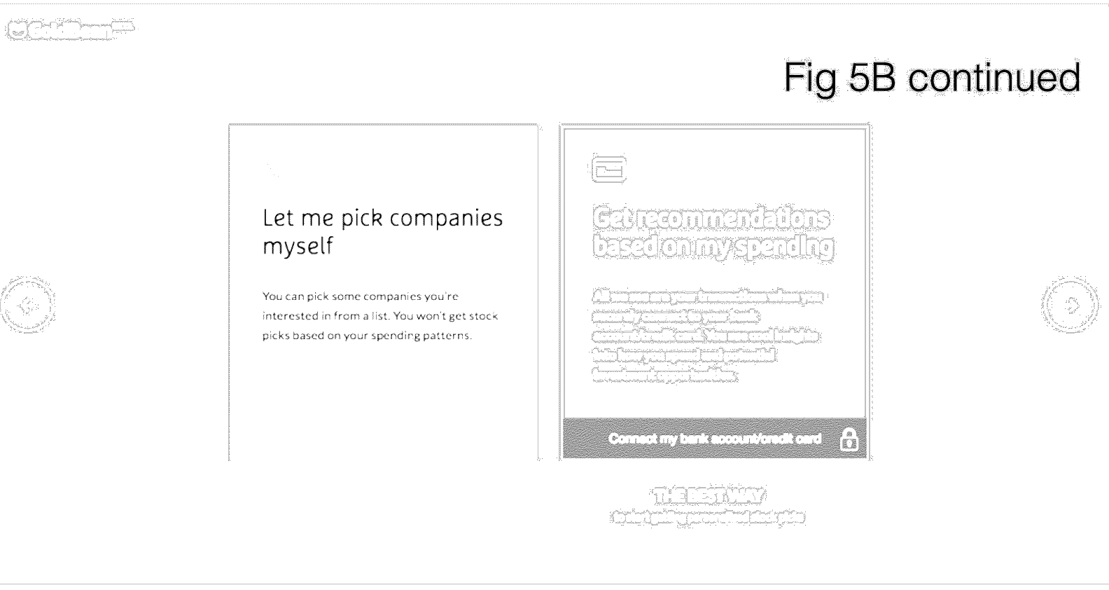

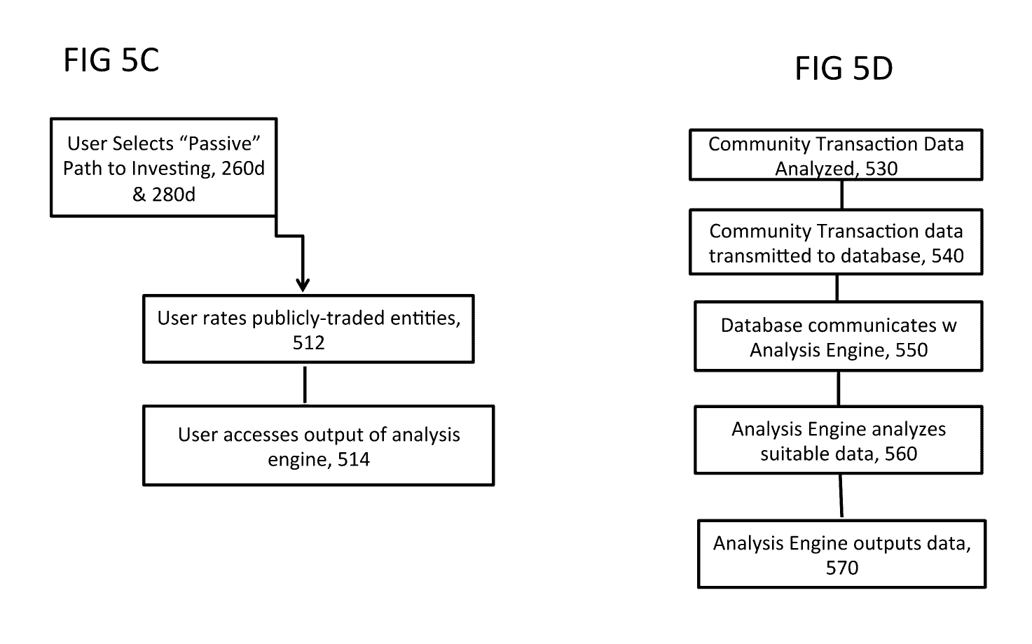

### FIG. 5A:

FIG. 5A shows a more detailed example of the process of Step 280d from FIG. 2A, as described from a user perspective, according to at least some embodiments of the present invention.

In an exemplary embodiment, when a user selects a “Passive” path to investing, a user's personal transactional data is not collected or analyzed. Instead, for example, a user could be offered the option to invest in existing suitable financial products, based on demographic and financial information generated by the user, in accordance with securities regulation and industry standards. An example of a suitable product that might be offered to a user is an exchange-traded fund (ETF). An exchange-traded fund is a security that tracks an index, a commodity or a basket of assets like an index fund, but trades like a stock on an exchange.

One skilled in the art will appreciate that there are many types of suitable investment products that could be offered to a user if a user selects a “Passive” path to investing. One skilled in the art will also appreciate that as new types of investment products are created and approved by securities regulators, these products may also be offered to users.

Beginning with Step 502 of FIG. 5A, a screen is displayed to a user via a user interface, which contains information about suitable financial products for the user, informed by user-generated demographic, financial, and investment risk tolerance data. Educational information regarding the products listed, such as the definition of the product and accompanying relevant details regarding the product's performance, may also be displayed to a user at this time.

In an exemplary embodiment the list of suitable products may be split by their risk level and displayed to the user in different groupings. For example, in Step 504 of FIG. 5A, a list of suitably aggressive products, such as the Equity Dividend Fund (MADVX) and the Global Dividend Fund (BIBDX), may be displayed as potential investment opportunities for a user.

Further in Step 506 of FIG. 5A, a list of suitably conservative products, such as the Emerging Markets Minimum Volatility Fund (EEMV), and the EAFE Minimum Volatility Fund (EEAV), may be displayed as potential investment opportunities for a user. Educational information regarding the products listed, such as the definition of the product and other relevant details regarding the product's performance, may also be displayed to a user at this time as well.

In an exemplary embodiment, detailed information is displayed to the user regarding each investment product such as the full name of the product or fund, the corresponding ticker symbol for the product or fund, the cost per share of the product or fund, and the average year-to-date return for the product or fund. Some embodiments may contain all, some, or none of this detailed information regarding each suitable product. These examples should not be interpreted as limitations on future embodiments.

Further, in an exemplary embodiment, lists of both suitably aggressive products and suitably conservative products may be displayed at the same time via a user interface. One skilled in the art will appreciate that this is not a requirement, and information about suitable products grouped by risk-level may be displayed to the user at different times. It is also important to note that suitable products may be displayed to the user according to verticals other than risk-level, such as highest average yearly return.

Continuing the process for a user who selects the “Passive” path to investing in Step 508, a user is displayed an option to select the “Personal” path to investing.

Concluding in Step 510, a user optimally selects the option to begin the “Personal” path to investing, as depicted in Step 280c, and as previously described further in FIG. 3A and FIG. 4. In an exemplary embodiment Step 510 of FIG. 5A would activate the processes for a user who selects the “Personal” path to investing described in detail previously in FIG. 3A and FIG. 4.

### FIG. 5B

FIG. 5B depicts an arrangement of possible words and images that may be displayed via a user interface to a user who chooses the “Passive” path to investing as depicted and described in FIG. 5A.

### FIG. 5C

FIG. 5C depicts a more detailed alternative example of the process of Step 280d and 260d from FIG. 2A and 2B respectively, as described from a user perspective, according to at least some embodiments of the present invention.

Continuing the process for a user who selects the “Passive” path to investing, in step 514, the user accesses the personalized advice via a user interface (110).

In one embodiment, the advice may be displayed to a user via a user interface in the form of a chart, list, or other similar tool for organizing information. The chart may be given a name such as a “Model Portfolio”. The chart may correspond to a list of personalized investment opportunities optionally informed by the output of analysis engine 113.

Alternatively and optionally, the output of analysis engine 113 may not be referred to as a “Model Portfolio”, but may be referred to as “recommendations”, “advice”, or another name, and may be displayed to the user in a manner similar to what is depicted in screenshots 3E1 and 3E2.

In one embodiment the “Model Portfolio” may contain names of various publicly traded entities from a system users whose demographic data are similar to the user interacting with the system, Exchange Traded Funds that match an individual's risk profile, the ticker-symbol used to represent those entities on various exchanges, the current price of those entities and an option for the user to purchase shares of the entity (virtually or actually), or simply watch the entity by placing them in a “Watchlist”.

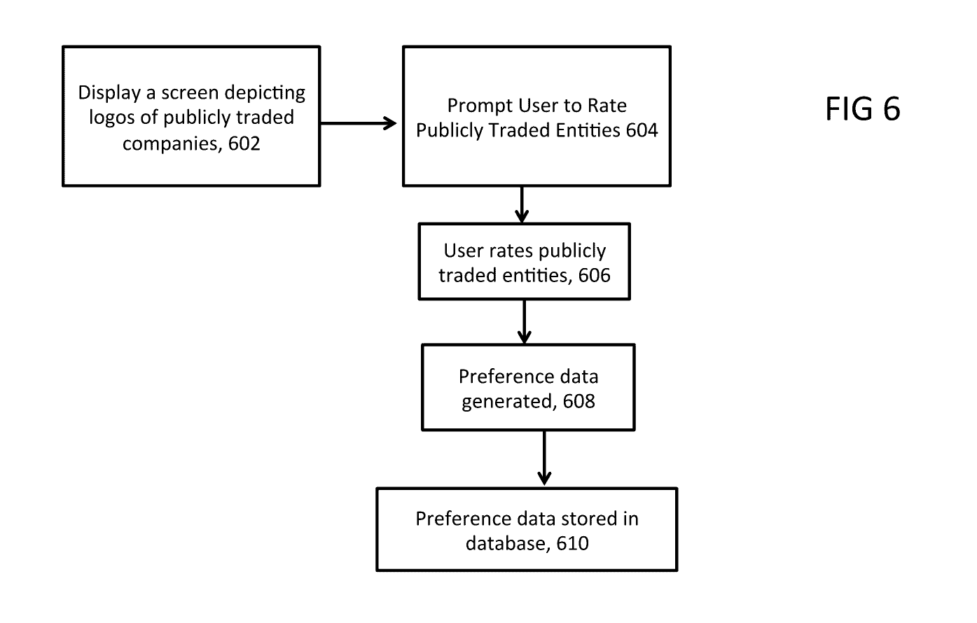

### FIG. 6

FIG. 6 depicts a more detailed description of the process in Step 304 of FIG. 3A, according to at least some embodiments of the present invention.

Beginning in Step 602, for example, a screen is displayed via a user interface, containing images of logos of various publicly traded entities. In some embodiments the images correspond to recognized logos of various publicly traded entities. Further, images of logos may be displayed of companies who are not listed on any securities exchange, but their parent company is.

Further, in an exemplary embodiment, logos of various publicly traded entities may be organized according to industry. Exemplary industries include, but are not limited to: technology and social media companies (e.g., Google, LinkedIn, Twitter, Facebook), electronics companies (e.g., Apple, Samsung, Microsoft, Sony), automobile companies (e.g., Ford, General Motors, Chrysler, BMW), entertainment companies (e.g., HBO, MTV, NBC), retail companies (e.g., Saks Fifth Avenue, Target, Gap, Wal-Mart), restaurants (e.g., Subway, McDonalds, Chipotle, Starbucks), news companies (e.g., The New York Times, USA Today, The Huffington Post), telecommunications companies (e.g., AT&T, Verizon, T-Mobile, Sprint) and others. One skilled in the art will appreciate that new logos may be displayed to a user for rating via a user interface as existing companies complete initial public offerings and list on various securities exchanges.

Continuing in Step 604, a user is prompted to rate the publicly traded entities that are present on the screen via a user interface. In an exemplary embodiment, the user may be prompted to rate publicly traded entities on a binary scale of either “love” or “hate”. One skilled in the art will appreciate that other rating schemas may be used to generate more nuanced user-preference data regarding various publicly traded entities. For example, a user may be prompted to rate entities according to a sliding scale of “like and dislike, with 1 resembling, a strong negative sentiment, and 10 representing a strong positive sentiment, for example.

Further in Step in 608, preference data is generated based on user ratings of publicly traded entities via a user interface. For example, a user may indicate a positive sentiment toward a particular publicly traded entity via a user interface, generating the user's preference data.

Finally in Step 610, user-generated preference data is transmitted and stored in a database via a data interface. In an exemplary embodiment user-generated preference data is analyzed by an analysis engine and may serve further as a contributing component to the final output of the analysis engine, for example.

In an exemplary embodiment, the process described in FIG. 6 is accessible to both a user who chooses the “Personal” path to investing as depicted in FIG. 280a (and in further detail in FIG. 3A, and 4), as well as a user who chooses the “Passive” path to investing as depicted in FIG. 280b.

### FIG. 7

FIG. 7 shows an exemplary, illustrative non-limiting embodiment of analysis engine 113 from FIG. 1.

In an exemplary embodiment, analysis engine 113 is configured to receive and analyze data regarding publicly traded entities across all, some, or a mix of verticals: financial performance, sentiment, user transaction data, and user enrollment data.

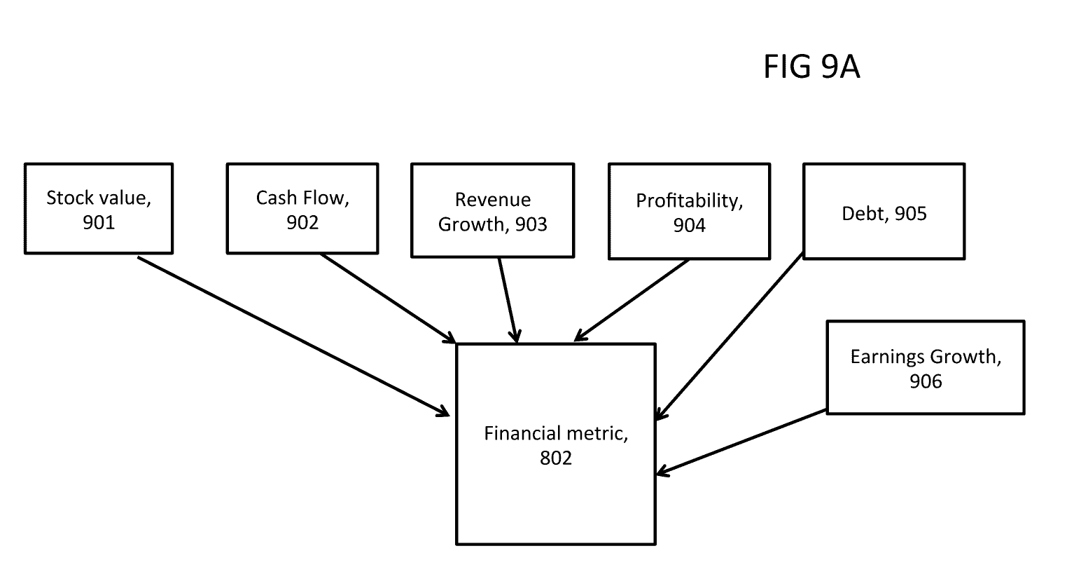

Analysis engine 113 receives data regarding publicly traded entities across either one, two or all of the above mentioned verticals, financial performance, sentiment and user transaction data. Analysis engine 113 also receives profile data regarding each user, optionally for example via user registration module 140. Exemplary inputs into each one of the verticals are discussed further in the drawings in FIGS. 9-16.

A value generator 702 may optionally analyze data regarding various publicly traded entities that reaches analysis engine 113, for example analyzing data points regarding publicly traded entities relatively and ascribing a new set of values to the various data points, for example in the form of a score. In an exemplary embodiment there may be a financial score, a sentiment score and a user transaction data score.

In one embodiment, analysis engine 113 may receive sales figures data over a given period of time for a publicly traded entity. At Value generator 702, sales figures data for a publicly traded entity might be analyzed by a value generator, which may analyze the data and ascribe a new value to it, for example a number in a pre-determined and defined range, such as a score.

In one embodiment, analysis engine 113 may receive sentiment data over a given period of time for a publicly traded entity. At Value generator 702, a value generator might analyze sentiment data for a publicly traded entity, 702, which might analyze the data and ascribe a new value to it, for example, a number in a pre-determined and defined range, such as a score.

In one embodiment, analysis engine 113 may optionally receive user transaction data over a given period of time for a publicly traded entity. At Value generator 702, a value generator might analyze user transaction data for a publicly traded entity 702, which might analyze the data and ascribe a new value to it, for example, a number in a pre-determined and defined range, such as a score.

In an exemplary embodiment, analysis engine 113 may receive data regarding both of the above-mentioned verticals (financial data, and sentiment data, and user transaction data) over a given period of time for a publicly traded entity. At Value generator 702, a value generator might analyze data regarding each of the above-mentioned verticals for a publicly traded entity, 702, which might analyze the data and ascribe a new value to each unique data point, for example, a number in a pre-determined and defined range, such as a score.

In heuristics 704, the output of the analysis of Value generator 702, which may be in the form of a number such as a score in a pre-determined and defined range, is further analyzed using a set of heuristics.

The outputs of Value generator 702 may be further analyzed and might be weighted, for example, in order to determine a final value, such as a number in a pre-determined and defined range, for any given publicly traded entity.

In one embodiment, a set of heuristics 704 may optionally ascribe a weight of 25% to the value input 901 depicted in FIG. 9, with the remainder weight split equally amongst the other inputs depicted in FIG. 9: cash flow 902, revenue growth 903, profitability 904, debt 905, and earnings growth 906, in order to determine a final financial metric, 802.

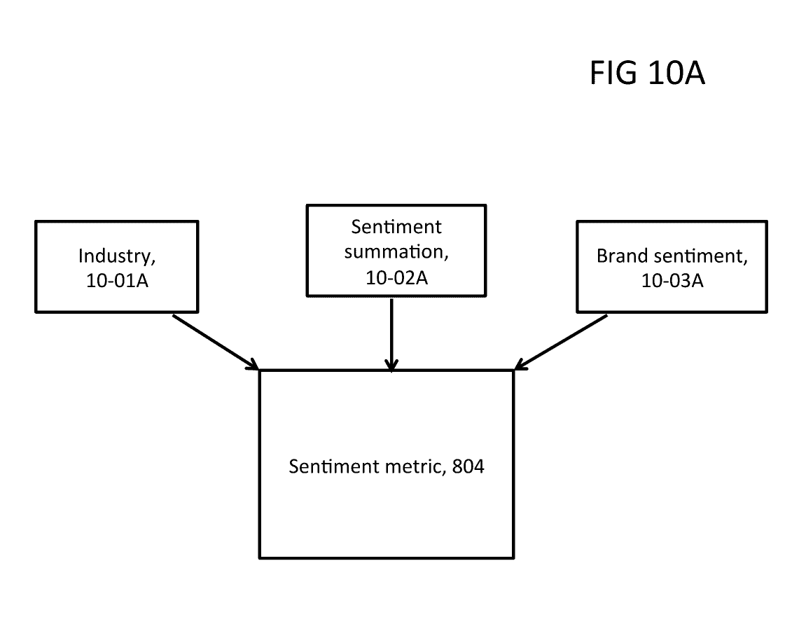

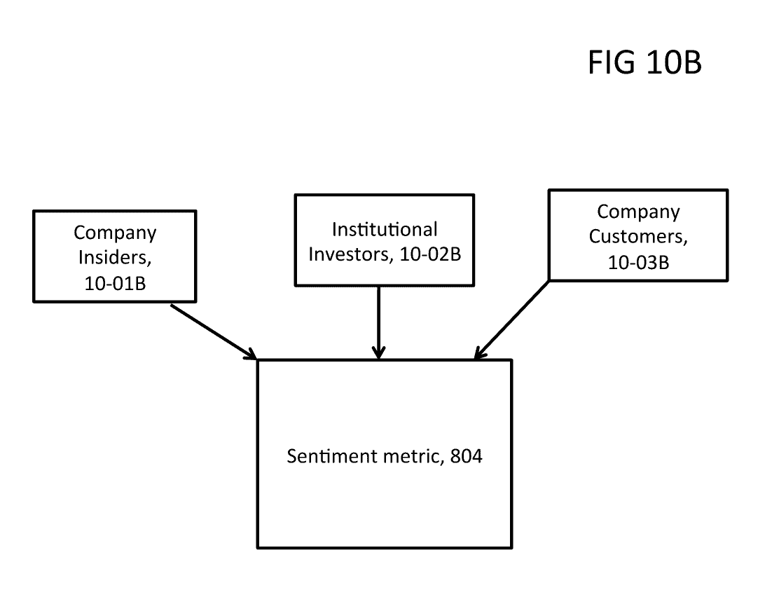

In one embodiment, a set of heuristics 704 may optionally ascribe an equal weight between each input depicted in FIG. 10A: company insiders 10-01A, institutional investors 10-02A, and users 10-03A, in order to determine a final sentiment metric, 804.

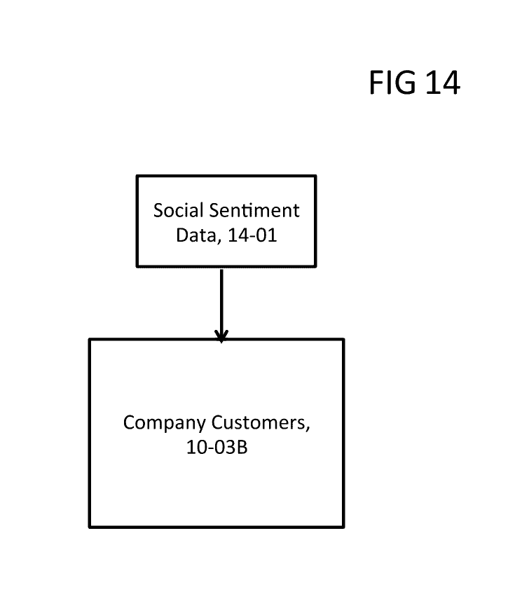

In one embodiment a set of heuristics 704 might ascribe a minimum weight of 50% to user spending history 14-01 as depicted in FIG. 14, while the remainder weight might be split equally between the remaining inputs, social sentiment data 14-02, and user portfolio holdings, 14-0, in order to determine a final user transaction data metric, 806.

The financial metric 802, the sentiment metric 804, and the user transaction data metric 806, might be numbers in a predetermined and defined range, for any given publicly traded entity. The range may be from 1-100 for example.

In one embodiment, output scores from Value generator 702 for each of the verticals (financial, sentiment, and user transaction data), might be weighted in relation to one another and aggregated into a single score in order to determine a potentially positive investment opportunity.

In one embodiment, the scores from Value generator 702 may be utilized by the heuristics in Heuristics 704 to weigh each score equally (⅓ financial, ⅓ sentiment, ⅓ spending). In another embodiment, the weighting of the scores from Value generator 702 will be weighted by the heuristics in Heuristics 704 equally between financial and sentiment data.

It should be noted that weighting is meant as an illustrative, non-limiting exemplary analysis process for a given set of heuristics in Heuristics 704, and that other analysis methods may act upon outputs received from Value generator 702 to determine signals received by analysis engine 113 and a potentially positive investment opportunity.

### Balance Module 705

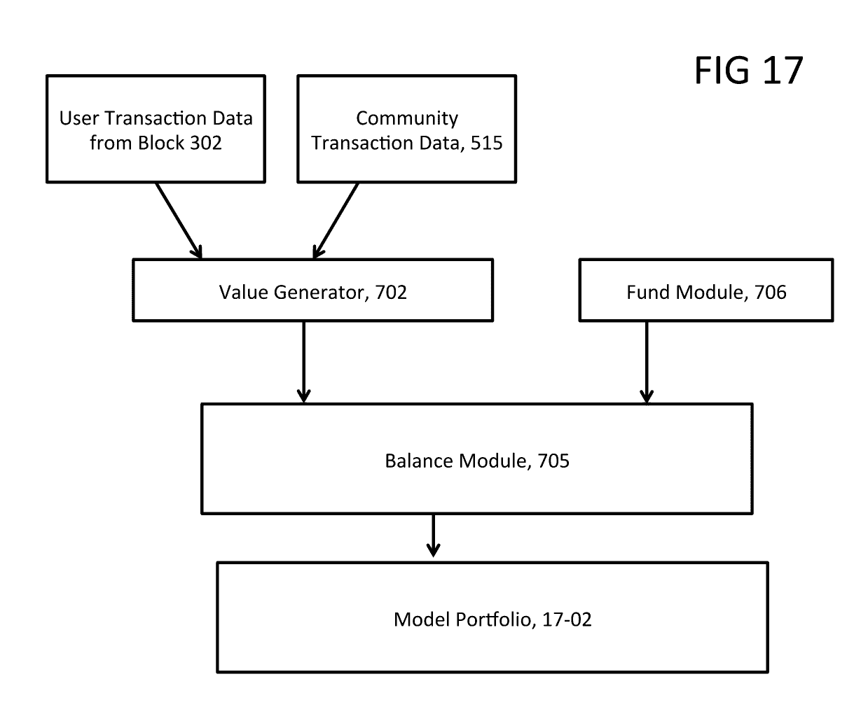

A balance module 705 may optionally analyze data regarding users' risk profiles and investment goals that reaches analysis engine 113. An exemplary balance module 705 may analyze data points regarding a user's profile, and use heuristics 704 to ascribe a model balance, in the form of a score. In an exemplary embodiment, Portfolio Generator 709 uses this score to define the weight of stocks, funds and cash that is used for a user's Model Portfolio as depicted in FIG. 17. The user's Model Portfolio comprises a set of data with the weighting for the various elements as described herein and which is preferably shown to the user as a Model Portfolio.

In one embodiment, analysis engine 113 may receive user enrollment data 230 data for a user. At balance module 705, age, marital status, income, net worth might be analyzed and a new value may be ascribed to each, for example a number in a pre-determined and defined range, such as a score.

In heuristics module 704, the output of the analysis of balance module 705, which may optionally be in the form of a number such as a set of scores in a pre-determined and defined range, is further analyzed using a set of heuristics.

The outputs of balance module 705 may be further analyzed by heuristics module 704 and may optionally be scored, for example, in order to determine a risk value. In one embodiment, the final score will give a value for an acceptable level of risk allowed in a model portfolio. Cash holdings may be 10% of stock holdings and funds will be the remainder.

In one embodiment, the final score of balance module balance module 705 is determined by heuristics 704. The score is determined by a weighted average of age, financial situation and experience scores with the maximum weight to age being 60% of the total, the maximum weight of experience being 30% and the maximum weight of income being 10% of the total.

In an exemplary embodiment, the final score from balance module 705 is used as the percentage of a model portfolio that can hold stock.

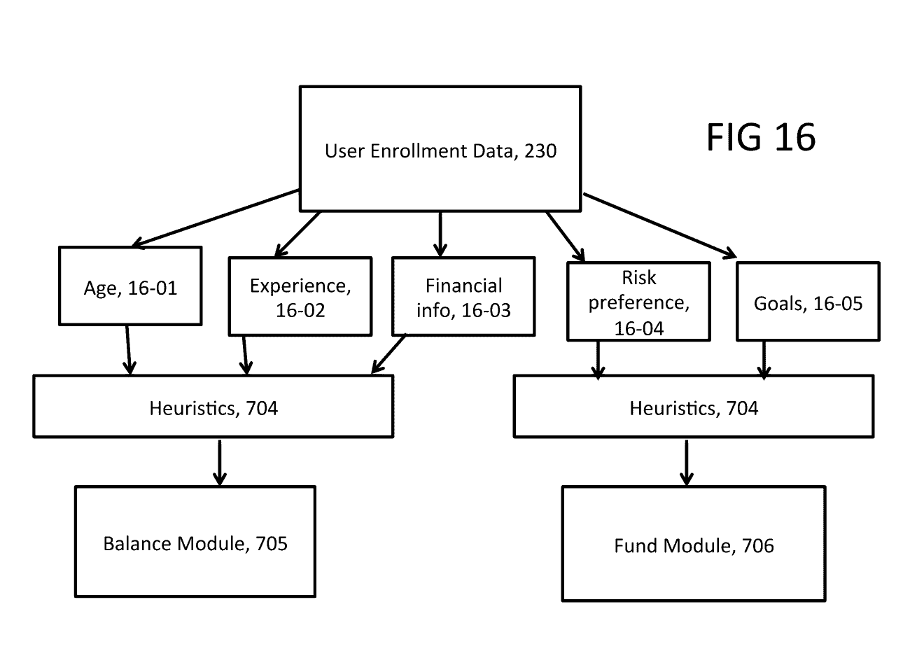

Further information about balance module 705 is described in FIG. 16.

### Fund Module 706

A fund module 706 may optionally analyze data regarding users' preferences that reaches analysis engine 113. An exemplary fund module 706 may optionally analyze data points regarding a user's preferences, and use heuristics 704 to ascribe a fund target, for example in the form of a score. In an exemplary embodiment the score is used by Portfolio Generator 709 to determine specific funds included in a Model Portfolio shown in FIG. 17.

In one embodiment, analysis engine 113 may receive user enrollment data for example as depicted in Step 230 for a user. At fund module 706, risk preference and investment goals might be analyzed and a new value may be ascribed to each, for example a number in a pre-determined and defined range, such as a score.

In heuristics 704, the output of the analysis of fund module 706, which may be in the form of a number such as a set of scores in a pre-determined and defined range, is preferably further analyzed using a set of heuristics.

The outputs of fund module 706 may optionally be further analyzed by Heuristics 704 and might be scored, for example, in order to determine a risk tolerance. In one embodiment, the final score will give a value for an acceptable level of risk allowed in the fund portion of a model portfolio for a user.

In one embodiment, a final score of fund module 706 may be determined by heuristics 704. The score may be determined by a weighted average of risk preference and investment goals. The weight of the score may be equally split between the two values.

In an exemplary embodiment, the final score from fund module 706 may be used to select the two funds that most accurately reflect the risk level embodied by the risk score. Further information about fund module 706 is described in FIG. 16.

### Portfolio Generator 709

A portfolio generator, as depicted in Portfolio generator 709, may optionally generate a model portfolio based on the data regarding users' spending that reaches analysis engine 113, the outputs generated by value generator 702, balance module 705, and fund module 706. An exemplary portfolio generator 709 optionally and preferably outputs a Model Portfolio (shown in FIG. 17) consisting of stock, funds and cash.

In one embodiment, analysis engine 113 may receive user credit data 302 data for a user. At Portfolio generator 709, analysis engine 113 selects the 4 highest publicly listed companies above a threshold value. In this embodiment, this threshold value is preferably defined as the top 30% of stocks.

Portfolio generator 709 will build a portfolio, using these four stocks, at a weight determined by balance model 705.

Portfolio generator 709 will add two funds that match the risk level defined by fund module 706. The weight of the funds in relation to the total portfolio is determined by balance module 705.

Portfolio generator 709 will fill the remainder of the portfolio with cash, at a proportion determined by balance module, 705.

In an exemplary embodiment, Portfolio generator 709 will generate a Model Portfolio (shown in FIG. 17) consisting of potential positive investments of stocks, funds and cash, which reflect the user's risk level.

In one embodiment, output from analysis engine 113 as well as output from value generator 702, heuristics 704 and recommendation module 706 are transmitted and stored in analysis engine output database 708.

Analysis engine output database 708 may optionally further communicate with user interface 110 via a data interface 106 in order to display output of analysis engine 113 to the user. Exemplary output of analysis engine 113 include: output across any or all of the verticals from Value generator 702, output across any or all of the verticals from Heuristics 704, output across any or all of the verticals in fund module 706, or output across any or all of the verticals from Value generator 702, heuristics 704, and/or fund module 706 for any given publicly traded entity.

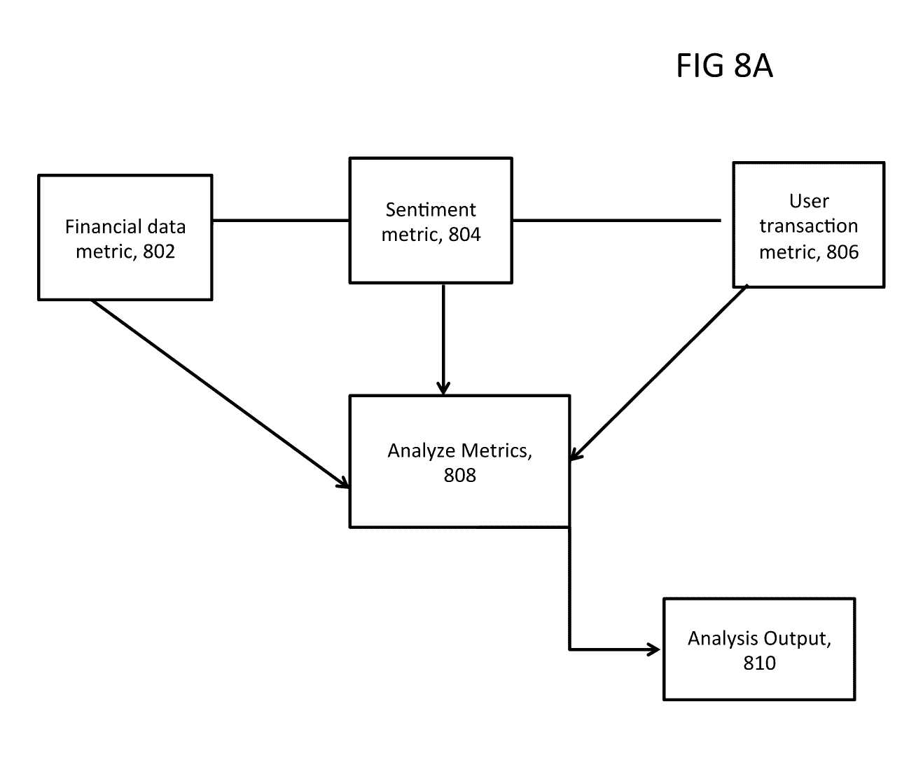

### FIG. 8

FIG. 8A depicts exemplary data metrics to be analyzed by an exemplary analysis engine.

Block 802 depicts a potential financial data metric input into an exemplary analysis engine according to at least some embodiments of the present invention. In one embodiment, the financial data metric estimate depicted in block 802 is informed at least in part by data from an external data feed, such as the one depicted in FIGS. 1A and 1B.

For example, the financial data metric estimate in block 802 may include data from an external data feed provider that provides real-time technical market data, such as the New York Stock Exchange (NYSE). It should be noted that the financial data metric estimate may be informed by data feeds from other vendors and sources then the exemplary ones listed above. Exemplary inputs to block 802 are discussed further in the descriptions in FIG. 9A.

Block 804 depicts an exemplary sentiment analysis metric according to at least some embodiments of the present invention. The sentiment analysis metric is informed at least in part by data from an external data feed, such as the one depicted in FIGS. 1A and 1B. For example, the social media sentiment analysis metric may include data from an external vendor that provides social media sentiment analysis through proprietary natural language processing methods. In that case, the data may be in an aggregate or summarized form, or it may be entirely raw. In an exemplary embodiment, block 804 is informed by raw sentiment data accessed via an external data feed from a sentiment analysis provider. Exemplary Inputs to block 804 are discussed in more detail in FIG. 10.

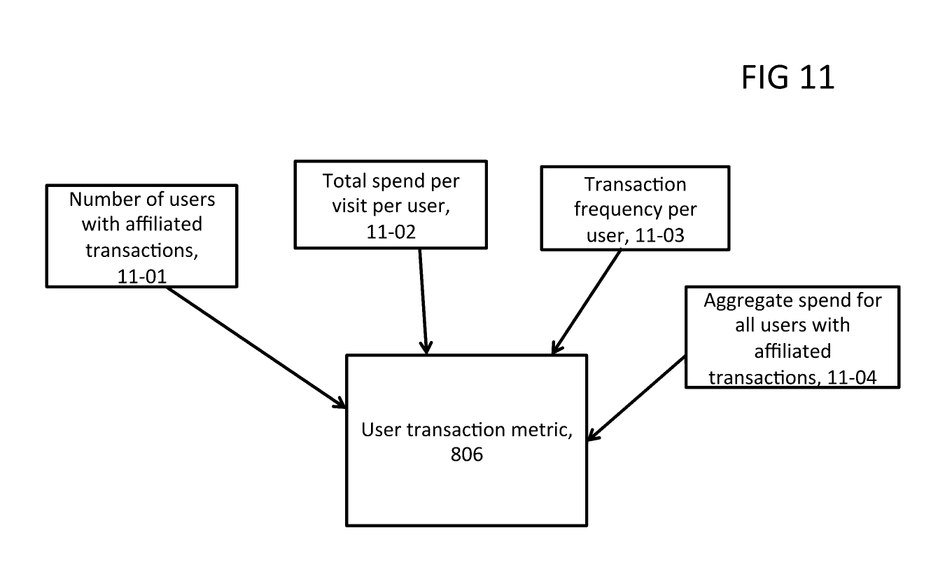

Block 806 depicts an exemplary user transaction data metric according to at least some embodiments of the present invention. The user transaction data metric is informed at least in part by user-generated transaction data from user credit/debit cards, obtained via a user registration module. Exemplary inputs to Block 806 are discussed in more detail in FIG. 11.

Block 810 depicts an exemplary output from block 802, block 804 and block 806, which is used by value generator 702 to build data required for portfolio generator 709.

### FIG. 9A

FIG. 9A depicts exemplary inputs into a metric based on financial data, as shown in Block 802.

Block 901 depicts an exemplary input, stock value. In one embodiment stock value may refer to the price to earnings ratio for a given stock of a publicly traded company. Price-to-earnings ratio can be understood as a valuation ratio of a company's current share price compared to its per-share earnings.

In another embodiment, stock value may refer to a stock's PEG ratio, or price-to-earnings to growth ratio. Price-to-earnings to growth ratio can be understood as stock's price-to-earnings ratio divided by the growth rate of its earnings for a specified time period.

In another embodiment, stock value may refer to a stock's dividend yield. A stock's dividend yield can be understood as a financial ratio that shows how much a given company pays out in dividends each year relative to its share price.

In yet another embodiment, stock value may refer to a stock's price-to-book ratio. A stock's price-to-book ratio can be understood as a ratio used to compare a stock's market value to its book value. It is calculated by dividing the current closing price of the stock by the latest quarter's book value per share.

In an exemplary embodiment, stock value refers to all of the components and measures described above as each one may be too narrowly focused to suffice as a single measure of stock value.

Block 902 depicts an exemplary input, cash flow, to a metric based on financial data, for example, as shown in Block 802. In one embodiment, cash flow refers to an accounting statement known as a “statement of cash flows”, which shows the amount of cash generated and used by a company in a given period. It is calculated by adding non-cash charges (such as depreciation) to net income after taxes, and can be understood as an indication of a company's financial strength, for example.

Block 903 depicts an exemplary input, revenue growth, to a metric based on financial data, for example, as shown in Block 802. In one embodiment, revenue growth can be understood as an increase of a company's sales when compared to a previous quarter's revenue performance, or a previous year's revenue performance. The current quarter's sales figure can be compared on a year-over-year basis or sequentially. This helps to give analysts, investors and participants an idea of how much a company's sales are increasing over time.

Block 904 depicts an exemplary input, profitability, to a metric based on financial data, for example, as shown in Block 802. In one embodiment profitability may refer to profit margin for a given company. Profit margin can be understood as ratio of profitability calculated as net income divided by revenues, or net profits divided by sales for a given company. It measures how much out of every dollar of sales a company actually keeps in earnings, and is often useful when comparing companies in similar industries.

In another embodiment, profitability may refer to return on assets for a given company. Return on assets can be understood as an indicator of how profitable a company is relative to its total assets. Return on assets can often shed light on how well management of a given company is at using the company's assets to generate earnings.

In yet another embodiment, profitability may refer to a measure such as return on equity for a given publicly traded entity. Return on equity can be understood as the amount of net income returned as a percentage of shareholders equity. Return on equity measures a given publicly traded entity's profitability by revealing how much profit a company generates with the money shareholders have invested in the company.

In an exemplary embodiment, profitability refers to all of the measures described above, as each one may be too narrowly focused to suffice as a single measure of profitability for a given publicly traded entity.

Block 905 depicts an exemplary input, debt, to a metric based on financial data. In one embodiment, debt can be understood as any ratio used to calculate the financial leverage of a company to get an idea of the company's methods of financing or to measure its ability to meet financial obligations.

In one embodiment, leverage may refer to debt to assets for a given company. Debt to assets can be understood as the amount of debt a company holds compared to its assets. It is an indicator of how much of a company's assets were financed by creditors. Debt to asset ratio can give an indication of how much financial risk a company has.

In another embodiment, leverage may refer to the quick ratio of a given company. A quick ratio is the amount of liquid assets a company has compared to its short-term debt. It is an indicator of how easily a company can meet it immediate financial obligations. It is a relevant indicator of financial risk.

Block 906 depicts an exemplary input, earnings growth in to a metric based on financial data. In one embodiment, earnings growth can be understood as the percentage gain in earnings per share over time for a company.

### FIG. 10A

FIG. 10A depicts exemplary inputs into a metric based on sentiment data, as shown in Block 804.

Block 10-01A depicts an exemplary input, industry, to a metric based on social media data, as shown in Block 804. In one embodiment, industry refers to an industry categorization corresponding to the publicly traded entity that is the subject of the social media data that is being analyzed.

Block 10-02A depicts an exemplary input, sentiment summation. Sentiment summation may refer to a metric used to estimate whether a piece of data received via an external data feed from a social media website, such as Twitter or Facebook, for example, represents a positive, negative, or neutral sentiment toward a given publicly traded entity.

In an exemplary embodiment, sentiment summation data is represented by an integer on a scale of +10 to −10 for example. In one embodiment, a sentiment summation score of +10 may refer to a highly positive sentiment, and a score of −10 may refer to a highly negative sentiment. Possible levels of sentiment include: positive, negative, and neutral. It should be noted that additional levels of sentiment are also possible, however: such as highly positive, highly negative, slightly positive, slightly negative, and the like.

Block 10-03A depicts an exemplary input, brand sentiment. Brand sentiment may refer to a measure of public sentiment toward a brand observed through social and traditional media, and brand research. This data may be provided by a vendor or obtained organically.

In one embodiment, sentiment summation data is provided by a vendor, which specializes in the matter. It should be noted that other inputs besides the ones set forth above may be used to derive a metric based on social media sentiment for a given publicly traded entity, as this list is not meant to be exhaustive.

FIG. 10B depicts alternative exemplary inputs into a metric based on sentiment data, as shown in Block 804.

The sentiment assessment aims to measure the potential of a company by gauging the expectations of the company's stakeholders.

The Sentiment Assessment may measure the expectations and actions of three main sets of stakeholders depicted in Blocks 10-01B-10-03B.

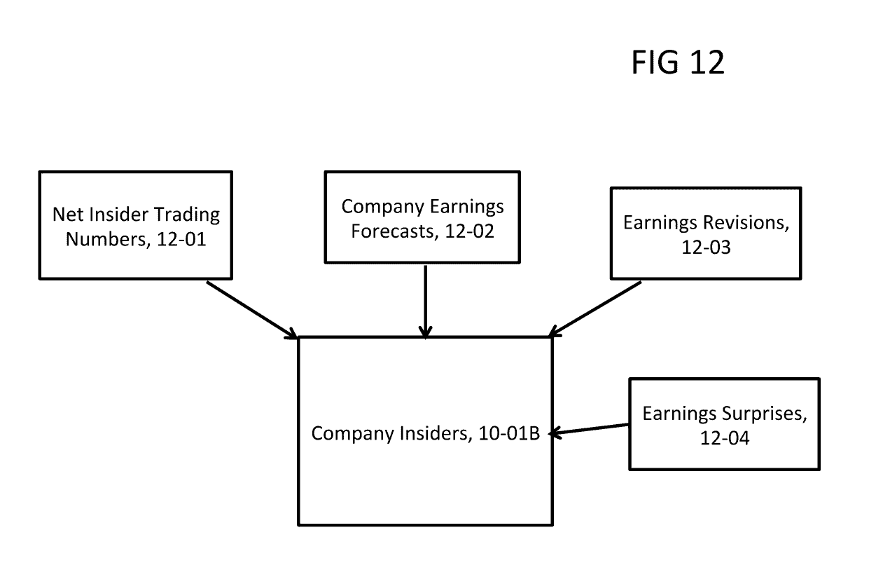

Block 10-01B depicts an exemplary input, Company Insiders, to a metric based on sentiment data as shown in Block 804. Block 10-01AB is further described in FIG. 12.

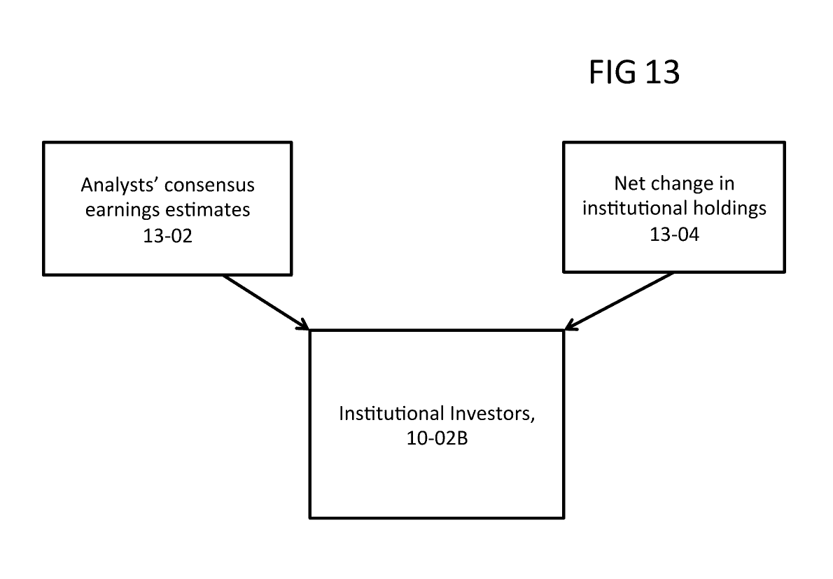

Block 10-02B depicts an exemplary input, Institutional Investors, to a metric based on sentiment data as shown in Block 804. Block 10-02B is further analyzed in FIG. 13.

Block 10-03B depicts an exemplary input, Users, to a metric based on sentiment data, as shown in Block 804. Block 10-03A is further analyzed in FIG. 14.

### FIG. 11

FIG. 11 depicts exemplary inputs into a metric based on user transaction data, as shown in Block 806.

Block 11-01 depicts an exemplary input to a metric based on user transaction data, number of users with affiliated transactions, which may refer to the number of users in a database who have purchases in their credit/debit card history affiliated with a given publicly traded company to be analyzed.

Block 11-02, depicts an exemplary input to a metric based on user transaction data, total spend per transaction per user, which may refer to the total amount in dollars per transaction per user for a given publicly traded entity.

Block 11-03 depicts an exemplary input to a metric based on user transaction data, transaction frequency per user, which may seek to quantify how a often a given user's credit/debit card history includes repeat transactions at a given publicly traded entity to be measured.

Block 11-04 depicts an exemplary input to a metric based on user transaction data, aggregate spend for all users with affiliated transactions, which may attempt to quantify the total spend by all users for a given publicly traded entity over a given period of time, such as a month, 6 months, or a year for example.

It should be noted that other inputs besides the ones set forth above may be used to derive a metric based on user transaction data regarding various publicly traded entities, as this list is not meant to be exhaustive. In an exemplary embodiment, user transaction data is optionally user-generated and accessed via a user registration module.

### FIG. 12

FIG. 12 depicts exemplary inputs related to Company Insiders as depicted in Block 10-01B into a metric based on sentiment data, as shown in Block 804.

The expectations of a company's managers and owners about a company's future can be measured in a number of ways. Some all or none of these measures may be considered:

Net Insider trading numbers in Block 12-01 may be an input to a measure related to Company Insiders for a metric based on sentiment data. Net Insider trading numbers could refer to the net buying or selling of company stock by directors, officers and beneficial owners (owners of 5% or more of company stock).

Earnings forecasts as reported by the companies themselves in Block 12-02 may be an input to a measure related to Company Insiders for a metric based on sentiment data. Earnings forecasts could refer to annual or quarterly forecasts of earnings, earnings per share or revenue announced by the company.

Earnings revisions in Block 12-03 may be an input to a measure related to Company Insiders for a metric based on sentiment data. This could refer to changes, upwards or downwards, in earnings forecasts by the company in the time before a scheduled earnings announcement.

Earnings surprises in Block 12-04 may be an input to a measure related to Company Insiders for a metric based on sentiment data. This could refer to the difference (higher or lower) in reported earnings from expected earnings as predicted by the company or by analysts.

### FIG. 13

FIG. 13 depicts exemplary inputs related to Institutional Investors as depicted in Block 10-02B into a metric based on sentiment data, as shown in Block 804.

The expectations of institutional investors about the potential of a company can be measured in a number of ways. Some, all, or none of these measures may be considered:

Analysts' consensus earnings estimates in Block 13-01 may be an input to a measure related to Institutional Investors for a metric based on sentiment data. This could refer to the reported average estimates of future company earnings as predicted by analysts.

Net change in institutional holdings in Block 13-02 may be an input to a measure related to Institutional Investors for a metric based on sentiment data. This could refer to the reported net change in company stock held by institutional investors (which could include pension funds, mutual funds, money managers, insurance companies, investment banks, commercial trusts, endowment funds and hedge funds).

### FIG. 14

FIG. 14 depicts an exemplary input related to Company Customers as depicted in Block 10-03B into a metric based on sentiment data, as shown in Block 804.

Social Sentiment data in Block 14-01 may be an input to a measure related to Company Customers for a metric based on sentiment data. This could include data about attitude and sentiment towards publicly listed companies and their brands from providers such as Twitter, Facebook and may also include data from news providers. Examples of this are described and depicted earlier in FIG. 10B.

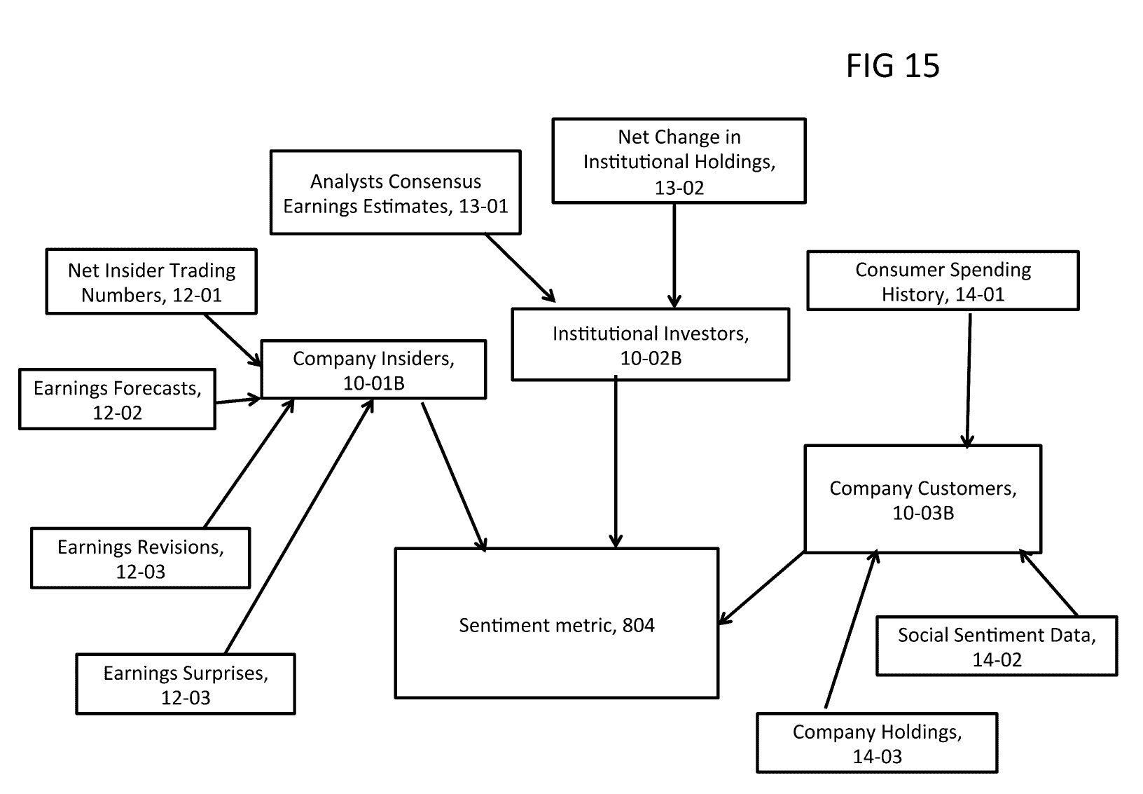

### FIG. 15

FIG. 15 depicts exemplary individual inputs to a Sentiment metric or Sentiment score depicted in Block 804. If data is not available for an individual input, that input may not be considered in the analysis and other available inputs may be considered or given more weight in the analysis.

In an exemplary embodiment, at Value generator 702, a value generator might analyze data regarding each of the above-mentioned individual inputs to a Sentiment metric or score for a publicly traded entity, (as depicted in FIG. 15), Value generator 702 might analyze the data and ascribe a new value to each unique data point, for example, a number in a pre-determined and defined range, such as a score.

It should be noted that weighting is meant as an illustrative, non-limiting exemplary analysis process for a given set of heuristics in Heuristics 704, and that other analysis methods may act upon outputs received from Value generator 702 to determine a potential correlation between the data received by analysis engine 113 and a metric such as stock price for a given publicly traded entity.

### FIG. 16

FIG. 16 depicts an exemplary embodiment and inputs into a balance module, 705, and a fund module 706.

A balance module 705 may optionally analyze data regarding users' risk profiles and investment goals that reaches analysis engine 113. Balance module 705 may optionally analyze data points from user enrollment data 230, and use heuristics 704 to ascribe a model balance, in the form of a score. In an exemplary embodiment there may be a model portfolio balance that defines the weight of stocks, funds and cash that a user's portfolio might hold.

In one embodiment, the final score of balance module 705 is determined by heuristics 704. The score is determined by a weighted average of various exemplary inputs including but not limited to age 16-01, financial situation 16-03, and experience 16-02. In one embodiment, the score is optionally weighted using age as 60% of the score, experience as 30% of the score and income being 10% of the score.

In an exemplary embodiment, the final score from balance module 705 is used as the percentage of a model portfolio that can hold stock.

A fund module 706 may optionally analyze data regarding users' preferences that reaches analysis engine 113. Fund module 706 may optionally analyze data points regarding a user's preferences, and use heuristics 704 to ascribe a fund target, for example in the form of a score. In an exemplary embodiment there may be a selection of funds that reflects the user's risk preference.

Further, in one embodiment, a final score of fund module 706 may be determined by heuristics 704. The score may optionally be determined by a weighted average of exemplary input risk preference 16-04 and investment goals 16-05. The weight of the score may optionally be equally split between the two values.

In an exemplary embodiment, the final score from fund module 706 may be used to pull the two funds that most accurately reflect the risk level embodied by the risk score.

### FIG. 17

FIG. 17 depicts an exemplary embodiment and exemplary inputs into a portfolio generator 709.

Portfolio generator 709 may optionally generate a model portfolio based on the data regarding users' spending that reaches analysis engine 113, the outputs generated by value generator 702, balance module 705, and fund module 706. As an example portfolio generator 709 outputs a Model Portfolio (shown in FIG. 17) consisting of stock, funds and cash.

In one embodiment, analysis engine 113 may receive user credit data 302 data for a user. At Portfolio generator 709, analysis engine 113 might select the four highest publicly listed companies above a threshold value. In one embodiment, this threshold value will be defined as the top 30% of all of the publicly listed companies in the system for example. In this embodiment, Portfolio generator 709 may then build a portfolio, using these four stocks, at a weight determined by balance model 705.

Further, Portfolio generator 709 might add two funds that match the risk level defined by fund module 706. The weight of the funds in relation to the total portfolio is determined by balance module 705. The remainder of the portfolio may be filled with cash, as determined by balance module 705.

In an exemplary embodiment, a user will have a Model Portfolio (shown in FIG. 17) that contains a balance of stocks, funds and cash that reflects his or her risk profile. The stocks in this portfolio may contain companies that the user spends money with and is familiar with.

In another embodiment, analysis engine 113 may not receive user transaction data 302 data for a user, or may not have adequate data for analysis. At Portfolio generator 709, analysis engine 113 may rely on user transaction data from individuals who have a similar demographic background to the user interacting with the system, as previously described with regard to FIG. 5, also called “community transaction data.” The community transaction data from FIG. 5 and outputs generated by value generator 702, balance module 705, and fund module 706 may further optionally be combined in an exemplary portfolio generator, 709, that outputs a Model Portfolio (shown in FIG. 17) consisting of stock, funds and cash.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove.

Although the invention has been described in conjunction with specific embodiments thereof, it is evident that many alternatives, modifications and variations will be apparent to those skilled in the art. Accordingly, it is intended to additionally embrace all such alternatives, modifications and variations that fall within the spirit and broad scope of the appended claims.

What is claimed is:

1. A system for recommending at least one investment to a user, the system comprising a computer network, a user computer, said user computer comprising a user interface for interacting with the user, and a server in communication with said user computer through said computer network, said server receiving purchasing information about at least one purchase by the user, said server comprising an analysis engine for evaluating said purchasing information and for recommending at least one investment to the user through said user interface.

2. The system of claim 1, wherein said user interface comprises a web browser.

3. The system of claim 1, wherein said analysis engine further receives a rating of at least one publicly traded entity by the user through said user interface, such that said analysis engine correlates said rating and said purchasing information to recommend at least one investment to the user through said user interface.

4. The system of claim 3, wherein said analysis engine evaluates said purchasing information to discard any information not related to a publicly traded entity and/or a brand associated with a publicly traded entity.

5. The system of claim 4, wherein said analysis engine further comprises a value generator for receiving financial performance and social media sentiment about said at least one publicly traded entity by said analysis engine and for generating values about said at least one publicly traded entity, and a heuristics module for receiving said values, said rating and said purchasing information to determine a recommendation of said at least one investment.

6. The system of claim 5, wherein said investment is selected from the group consisting of a stock, a bond, an ETF (exchange traded fund), a money market fund, a derivative, an option and a future.

7. The system of claim 5, wherein said purchasing information comprises credit card purchase information, debit card purchase information and gift card purchase information.

8. The system of claim 7, wherein said server further comprises a data interface for receiving said purchasing information and a user credit card analyzer module for analyzing said credit card purchase information.

9. The system of claim 8, wherein said server further comprises a user registration module for receiving user registration information.

10. A method for recommending at least one investment to a user, comprising providing a system according to claim 1; receiving said purchasing information of the user by said server; analyzing said purchasing information by said analysis engine; receiving a rating indication for at least one publicly traded entity by said analysis engine from said user through said user interface; and recommending at least one investment to the user according to said analysis of said purchasing information and said rating indication through said user interface by said analysis engine.

11. The method of claim 10, further comprising receiving financial performance information about said at least one publicly traded entity by said analysis engine; wherein said recommending at least one investment further comprises correlating said financial performance information, said rating indication and said purchasing information to recommend said at least one investment by said analysis engine.

12. The method of claim 11, wherein said financial performance information comprises one or more of stock value, cash flow, revenue growth, profitability, leverage and earnings growth.

13. The method of claim 12, further comprising receiving social media metrics about said at least one publicly traded entity by said analysis engine; wherein said recommending at least one investment further comprises correlating said financial performance, said social media metrics, said rating indication and said purchasing information to recommend said at least one investment by said analysis engine.

14. The method of claim 13, wherein said social media metrics comprise one or more of industry social media sentiment, brand social media sentiment and publicly traded entity social media sentiment.

15. The method of claim 14 wherein said correlating further comprises weighting each of said financial performance, said social media sentiment, said rating indication and said purchasing information to recommend said at least one investment by said analysis engine.

16. The method of claim 15, wherein said weighting comprises determining a correspondence between said rating indication and said purchasing information; if said correspondence exists, increasing a relative weighting of said rating indication and said purchasing information.

17. The method of claim 16, further comprising analyzing said purchasing information to determine at least a transaction frequency and a transaction amount associated with each publicly traded entity or an associated brand thereof.

18. The method of claim 16, wherein said investment is selected from the group consisting of a stock, a bond, an ETF (exchange traded fund), a money market fund, a derivative, an option and a future.

19. The method of claim 16, wherein said purchasing information comprises credit card purchase information, debit card purchase information and gift card purchase information.

20. The method of claim 16, further comprising registering the user before performing said receiving said purchasing information; offering the user a choice of personal or passive investment through said user interface; only if the user selects said personal investment, proceeding with the method; otherwise offering the user a standard investment product through said user interface.
